(19) United States
(12) Patent Application Publication
(10) Pub. No.: US 2023/0394312 A1
(43) Pub. Date: Dec. 7, 2023

(54) PRUNING ACTIVATIONS AND WEIGHTS OF NEURAL NETWORKS WITH PROGRAMMABLE THRESHOLDS

(71) Applicant: Intel Corporation, Santa Clara, CA (US)

(72) Inventors: Soumendu Kumar Ghosh, Lafayette, IN (US); Shamik Kundu, Dallas, TX (US); Arnab Raha, San Jose, CA (US); Deepak Abraham Mathaikutty, Chandler, AZ (US)

(73) Assignee: Intel Corporation, Santa Clara, CA (US)

(21) Appl. No.: 18/453,715

(22) Filed: Aug. 22, 2023

Related U.S. Application Data
(60) Provisional application No. 63/515,903, filed on Jul. 27, 2023.

(51) Int. Cl. G06N 3/082; G06N 3/0464

(52) U.S. Cl. CPC G06N 3/082; G06N 3/0464

(57) ABSTRACT

Activations (e.g., output activations) or weights of intermediate layers of deep neural networks (DNNs) can be pruned to increase sparsity and reduce the amount of computation required for performing the computations in the layers or subsequent layers. A pruning threshold may be determined, e.g., through an iterative process, and activations or weights having absolute values lower than the pruning threshold may be changed to zero. A first pruning threshold may be used to prune an output tensor or kernel of a layer. The loss in the accuracy of the DNN due to the pruning may be determined. A second pruning threshold may be determined based on the first pruning threshold and the accuracy loss. The DNN may be modified by adding a pruning operation to the layer. The pruning operation can prune output tensors or kernels of the layer based on the second pruning threshold.

### CROSS REFERENCE TO RELATED APPLICATION

This application claims the benefit of U.S. Provisional Patent Application No. 63/515,903, filed Jul. 27, 2023, which is incorporated by reference in its entirety.

### TECHNICAL FIELD

This disclosure relates generally to deep neural networks (DNN), and more specifically, pruning activations and weights of DNNs with programmable thresholds.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN system, in accordance with various embodiments.

FIG. 4 illustrates a pruning operation by a sparsity encoder, in accordance with various embodiments.

FIG. 5 illustrates sparsity acceleration in an MAC operation by a processing element (PE), in accordance with various embodiments.

FIG. 6 is a block diagram of a DNN module, in accordance with various embodiments.

FIG. 7 is a block diagram of a compressing module, in accordance with various embodiments.

FIG. 8 illustrates selection of an optimal threshold for pruning activations, in accordance with various embodiments.

FIG. 9 illustrates selection of an optimal threshold for pruning weights, in accordance with various embodiments.

FIG. 10 illustrates selection of optimal thresholds for pruning activations and weights, in accordance with various embodiments.

FIG. 11 illustrates an example PE array, in accordance with various embodiments.

FIG. 12 is a block diagram of a PE, in accordance with various embodiments.

FIG. 13 is a flowchart showing a method of modifying a DNN, in accordance with various embodiments.

FIG. 14 is a flowchart showing another method of modifying a DNN, in accordance with various embodiments.

FIG. 15 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations (also referred to as “neural network operations”), such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

DNNs exhibit sparsity in the form of activations and weights, as many of these data elements can have zero values. These zeros do not contribute to the accumulation of partial sums during MAC operations. They can lead to sparsity in activations of subsequent layers after passing through nonlinear activation functions like rectified linear activation function (ReLU). Leveraging sparsity in DNN accelerators can be crucial for achieving efficient and scalable AI systems. By taking advantage of sparsity, DNN accelerators can reduce the amount of computation and memory accesses required for a given task, leading to faster and more energy-efficient inference. Sparsity can also enable the deployment of larger models with higher accuracy without requiring more expensive hardware.

Pruning is one of the currently available techniques for introducing sparsity in DNNs. Regularization techniques are used to prune weights. For example, L1 regularization (also known as Lasso regularization) penalizes the sum of absolute values of the weights, which encourages some of them to become zero, resulting in a sparse model. Another weight pruning approach reduces the size of the DNN by removing some of the connections or neurons that are less important for the network's performance. An example is magnitude-based pruning, where connections with small absolute values are removed. Also, various approaches for pruning activations have been explored, including stochastic activation pruning, transforming them into finite field vectors via nonlinear dimensionality reduction, incorporating 1,1-regularization and Hoyer regularization to boost activation sparsity. Also, thresholding techniques have been introduced to further amplify sparsity.

However, currently available sparsity injection techniques suffer from disadvantages. For example, these techniques can cause accuracy reduction, especially if not properly retrained with optimal setting of hyperparameters using the original training dataset. This is because connections between neurons in the network are removed, which can result in lost information and reduced performance. Sparsity injection can also increase the complexity of the network as additional computations are required to identify which connections to remove and which to keep. This can result in longer training times and more complex code. Further, these sparsity injection techniques can be difficult to implement. Emerging neural networks like transformers can pose constraints on these approaches on account of their inherent network architecture and non-ReLU based activations, such as Gaussian Error Linear Unit (GELU), SoftMax, Swish, Sigmoid.

Embodiments of the present disclosure provide methods and systems for pruning activations and weights based on programmable thresholds. An example DNN may be modified, e.g., after the DNN is trained, by adding pruning operations to one or more layers in the DNN. The layers may be intermediate layers. The layers may be selected based on one or more attributes related to computational complexity of the layers, such as the number of internal parameters (e.g., weights) in a layer, the number of operations (e.g., MAC operations) in a layer, the layer type, and so on. The pruning operations can introduce sparsity to the layers on top of any sparsity the layers already have. The extra sparsity can reduce computation complexity of these layers.

In various embodiments of the present disclosure, a pruning operation may be an activation pruning operation or a weight pruning operation. An activation pruning operation may prune activations, such as activations generated by a layer. A weight pruning operation may prune weights of the layer. In a pruning operation, one or more activations or weights having absolute values lower than a threshold may be modified to zero, while activation or weights having absolute values greater than or equal to the threshold may not be changed. The threshold may be programmable. The threshold may be determined before inference run-time, e.g., in the compilation stage. A programmable threshold can be specific to a particular layer or a particular type of layer.

In some embodiments, a layer may have more than one activation threshold or more than one weight threshold. For instance, a layer may have an activation threshold for pruning activations having positive values and a different activation threshold for pruning activations having negative values. The activation threshold for negative activations may have a positive value or negative value. The activation pruning operation may compare the absolute value of a activation threshold with the absolute value of the activations to which the activation threshold is applicable. Similarly, a layer may have a weight threshold for pruning weights having positive values and a different weight threshold for pruning weights having negative values. The weight pruning operation may compare the absolute value of a weight threshold with the absolute value of the weights to which the weight threshold is applicable.

An optimal threshold for a pruning operation may be searched through an iterative process that includes multiple rounds of searching. In each round, a dataset may be input into the DNN, and a different threshold may be used for the pruning operation added to one or more layers of the DNN. The loss in the accuracy of the DNN caused by the pruning operation may be measured and compared with the accuracy loss constraint. When the accuracy loss is lower than the accuracy loss constraint, the searching may continue, and a higher threshold may be used in the next round. When the accuracy loss is not lower than the accuracy loss constraint, the threshold used in the previous round may be selected as the optimal threshold. The DNN may be modified with the pruning operation using the optimal threshold. The modified DNN may be deployed for performing AI tasks.

Pruning operations may be performed in the compilation stage or be executed using existing sparsity hardware in DNN accelerators with limited or even no additional overhead in terms of area and power. Pruning operations can introduce sparsity in the incoming activations or weights before these data are stored in the DNN accelerator's memory and therefore, can reduce memory usage and the amount of computation and improve efficiency of the DNN accelerator.

The present disclosure provides an approach that can enhance sparsity in various network layers without the costly retraining process. It can target at nonlinear activations including ReLU as well as widely used activation functions including Sigmoid, GELU, and SoftMax in convolutional neural networks and transformers. This approach can optimize sparsity after normalization layers (e.g., LayerNorm) in transformers, improving efficiency in multilayer perceptron (MLP) and multi-headed attention layers. As programmable thresholds are determined based on accuracy loss constraints, the impact on DNN accuracy can be minimized while energy saving is maximized.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

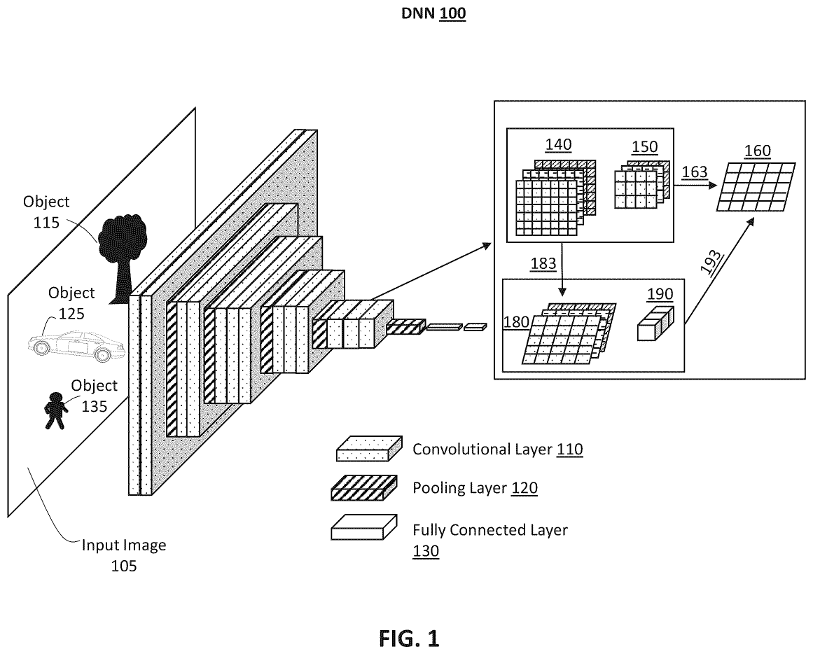

FIG. 1 illustrates an example DNN 100, in accordance with various embodiments. For the purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. AIl the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For the purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is ReLU. ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a SoftMax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, SoftMax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

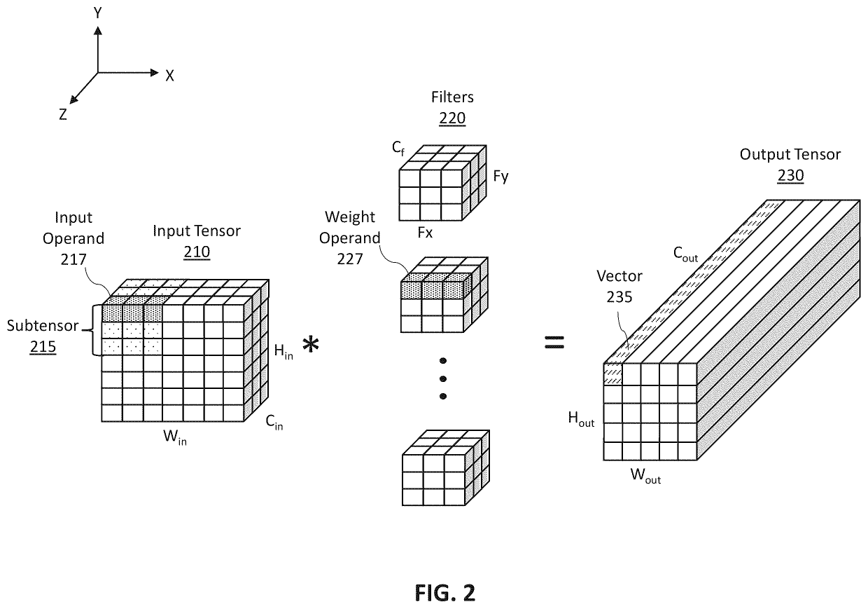

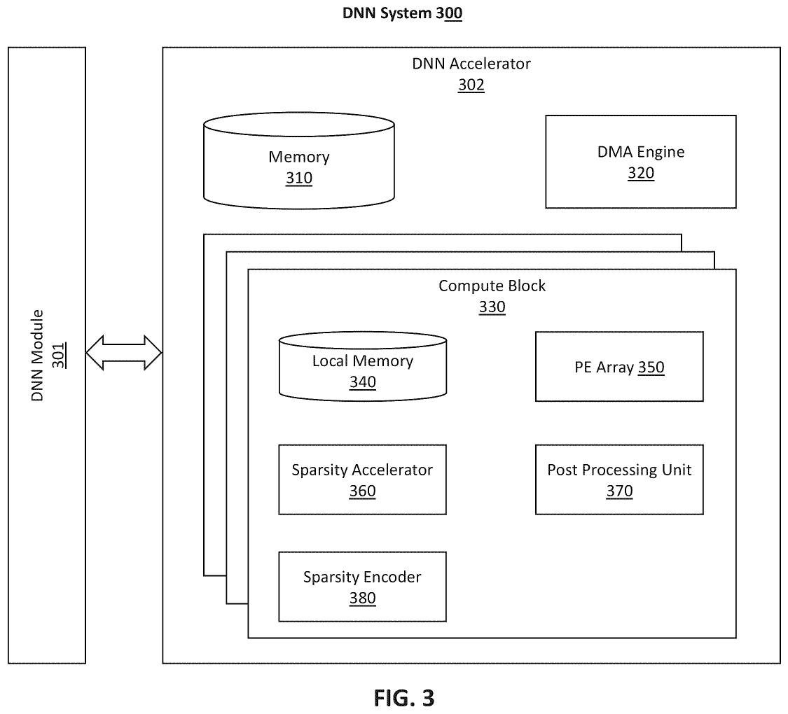

FIG. 2 illustrates an example convolution, in accordance with various embodiments. The convolution may be a deep learning operation in a convolutional layer of a DNN, e.g., a convolutional layer 110 in FIG. 1. The convolution can be executed on an input tensor 210 and filters 220 (individually referred to as “filter 220”). The result of the convolution is an output tensor 230. In some embodiments, the convolution is performed by a DNN accelerator. An example of the DNN accelerator may be the DNN accelerator 302 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For the purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 220 in FIG. 2 has a spatial size of 2×3×3, i.e., the filter 220 includes 2 convolutional kernels with a spatial size of 2×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and Cₒᵤₜ is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 2×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (X, Y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 2×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a PE. The PE may receive an activation and a weight (“an activation-weight pair”) at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 230 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 210 may be results of post processing of the previous DNN layer.

Example DNN System

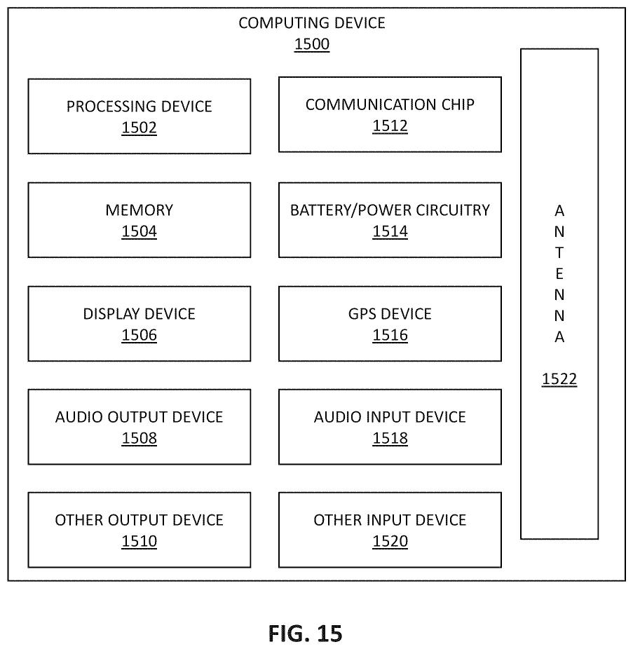

FIG. 3 is a block diagram of a DNN system 300, in accordance with various embodiments. The whole DNN system 300 or a part of the DNN system 300 may be implemented in one or more computing devices, such as the computing device 1500 in FIG. 15. The DNN system 300 can generate and execute DNNs, such as the DNN 100 in FIG. 1. As shown in FIG. 3, the DNN system 300 includes a DNN module 301 and a DNN accelerator 302. In other embodiments, alternative configurations, different or additional components may be included in the DNN system 300. For instance, the DNN system 300 may include multiple DNN modules or multiple DNN accelerators. Further, functionality attributed to a component of the DNN system 300 may be accomplished by a different component included in the DNN system 300 or a different system. In some embodiments, the DNN module 301 and DNN accelerator 302 may include different types of processing units. The DNN module 301 and DNN accelerator 302 may be implemented in the same chip or separate chips.

The DNN module 301 facilitates generation and deployment of DNNs. In some embodiments, the DNN module 301 may generate and train DNNs. For instance, the DNN module 301 can define the layered architecture of a DNN. The DNN module 301 can also determine the internal parameters of the DNN through a DNN training process. The DNN module 301 may also determine one or more hyperparameters that define how the DNN is trained. An example hyperparameter is a sparsity ratio that defines the sparsity level of one or more deep learning tensors for the DNN.

The DNN module 301 may also compress DNNs, e.g., after the DNNs are trained. The DNN module 301 may reduce the size of a DNN by adding pruning operations into one or more layers of the DNN. The DNN module 301 may select the one or more layers based on the computational complexity of the layers. A pruning operation may prune activations generated by a layer or prune weights in the layer, e.g., by modifying nonzero-valued activations or weight to zeros. The zeros may be skipped from memory storage and computation so that the DNN inference would consume less memory usage, power, and time. In some embodiments, the DNN module 301 may determine a threshold for a pruning operation. During the pruning operation, the absolute values of data elements (e.g., activations or weights) may be compared with the threshold, and data elements with absolute values lower than the threshold may be changed to zeros while data elements with absolute values greater than or equal to the threshold may remain the same. A pruning operation may be executed, e.g., by the DNN accelerator 302, during inference run-time. Alternatively, a pruning operation (e.g., a weight pruning operation) may be performed before the inference run-time. For instance, a weight pruning operation may be performed during the compilation stage after the DNN is trained.

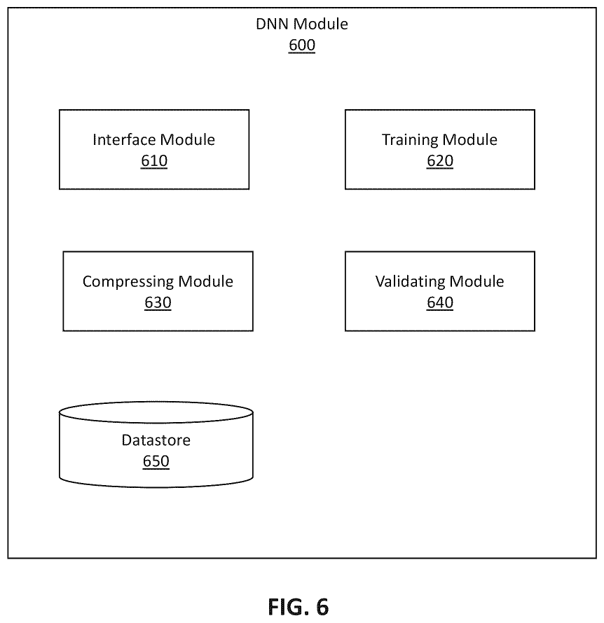

The DNN module 301 may deploy trained, compressed, or validated DNNs for use in deep learning applications. In some embodiments, the DNN module 301 may distribute trained, compressed, or validated DNNs to devices or systems which may use the DNNs to perform tasks (e.g., image classification, motion planning, etc.) for which the DNNs were trained. In other embodiments, the DNN module 301 may facilitate deployment of the DNNs using the DNN accelerator 302. For instance, the DNN module 301 may receive data from a device or system coupled with the DNN system 300 and input the received data (or data generated by the DNN module 301, e.g., based on the received data) into a DNN. The DNN module 301 may generate instructions (e.g., configuration files) that control the operation of the DNN accelerator 302 during the DNN inference. The DNN module 301 may receive an output of the DNN from the DNN accelerator 302. The DNN module 301 may transmit the output of the DNN (or a result of processing the output of the DNN by the DNN module 301) to the device or system. Certain aspects of the DNN module 301 are provided below in conjunction with FIG. 6.

The DNN accelerator 302 executes DNNs provided by the DNN module 301. For instance, the DNN accelerator 302 can perform DNN inference, e.g., by running deep learning operations in the DNNs, for training DNNs or for using the trained/compressed/validated DNNs to perform tasks. As shown in FIG. 3, the DNN accelerator 302 includes a memory 310, a DMA (direct memory access) engine 320, and compute blocks 330 (individually referred to as “compute block 330”). In other embodiments, alternative configurations, different or additional components may be included in the DNN accelerator 302. For example, the DNN accelerator 302 may include more than one memory 310 or DMA engine 320. As another example, the DNN accelerator 302 may include a single compute block 330. Further, functionality attributed to a component of the DNN accelerator 302 may be accomplished by a different component included in the DNN accelerator 302 or by a different system. A component of the DNN accelerator 302 may be implemented in hardware, software, firmware, or some combination thereof.

The memory 310 stores data associated with deep learning operations performed by the DNN accelerator. In some embodiments, the memory 310 may store data to be used by the compute blocks 330 for DNN inference. For example, the memory 310 may store weights, such as weights of convolutional layers, which are determined by training DNNs. The memory 310 may also store weight thresholds for pruning weights. As another example, the memory 310 may store activation thresholds, such as activation thresholds for pruning activations generated by intermediate layers of DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 302. In some embodiments, the memory 310 includes one or more DRAMs (dynamic random-access memory).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330. A compute block 330 may also be referred to as a compute tile. In some embodiments, each compute block 330 may be a processing unit.

In the embodiments of FIG. 3, each compute block 330 includes a local memory 340, a PE array 350, a sparsity accelerator 360, a post processing unit 370, and a sparsity encoder 380. Some or all the components of the compute block 330 can be implemented on the same chip. In other embodiments, alternative configurations, different or additional components may be included in the compute block 330. Further, functionality attributed to a component of the compute block 330 may be accomplished by a different component included in the compute block 330, a different compute block 330, another component of the DNN accelerator 302, or a different system. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. The local memory 340 may store data received, used, or generated by the PE array 350 and the post processing unit 370. Examples of the data may include input activations, weights, output activations, sparsity bitmaps, and so on. The local memory 340 may also include activation thresholds or weight thresholds for pruning activations or weights. Data in the local memory 340 may be transferred to or from the memory 310, e.g., through the DMA engine 320. In some embodiments, data in the local memory 340 may be transferred to or from the local memory of another compute block 330.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 356, 512, 1024, 3048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The PE array 350 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 350 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 350 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 350 may perform MAC operations in quantized inference, such as MAC operations in a quantized convolution. In some embodiments, a PE in the PE array 350 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The sparsity accelerator 360 accelerates computations in the PE array 350 based on sparsity in activations or weights. In some embodiments (e.g., embodiments where the compute block 330 executes a convolutional layer), a computation in a PE may be a MAC operation on an input operand and a weight operand. The input operand may include one or more activations in the input tensor of the convolution. Different activations may be in different input channels. The weight operand may include one or more weights in the filter of the convolution. The values of the weights are determined through training the DNN. The weights in the weight operand may be in different input channels.

In some embodiments, the input operand is associated with an activation bitmap, which may be stored in the local memory 340. The activation bitmap may be generated by the sparsity encoder 380. The activation bitmap can indicate positions of the nonzero-valued activations in the input operand. The activation bitmap may include a plurality of bits, each of which corresponds to a respective activation in the input operand. The position of a bit in the activation bitmap may match the position of the corresponding activation in the input operand. A bit in the activation bitmap may be zero or one. A zero-valued bit indicates that the value of the corresponding activation is zero, a one-valued bit indicates that the value of the corresponding activation is nonzero. In some embodiments, the activation bitmap may be generated during the execution of another DNN layer, e.g., a layer that is arranged before the convolutional layer in the DNN.

In some embodiments, the weight operand is associated with a weight bitmap, which may be stored in the local memory 340. The weight bitmap may be generated by the sparsity encoder 380. The weight bitmap can indicate positions of the nonzero-valued weights in the weight operand. The weight bitmap may include a plurality of bits, each of which corresponds to a respective weight in the weight operand. The position of a bit in the weight bitmap may match the position of the corresponding weight in the weight operand. A bit in the weight bitmap may be zero or one. A zero-valued bit indicates that the value of the corresponding weight is zero, a one-valued bit indicates that the value of the corresponding weight is nonzero.

In some embodiments, the sparsity accelerator 360 may receive the activation bitmap and the weight bitmap and generate a combined sparsity bitmap for the MAC operation to be performed by the PE. In some embodiments, the sparsity accelerator 360 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are nonzero. The combined sparsity bitmap may be stored in the local memory 340.

The sparsity accelerator 360 may provide activations and weights to the PE based on the combined sparsity bitmap. For instance, the sparsity accelerator 360 may identify one or more nonzero-valued activation-weight pairs from the local memory 340 based on the combined sparsity bitmap. The local memory 340 may store input operands and weight operands in a compressed format so that nonzero-valued activations and nonzero-valued weights are stored but zero-valued activations and zero-valued weights are not stored. The nonzero-valued activation(s) of an input operand may constitute a compressed input operand. The nonzero-valued weight(s) of a weight operand may constitute a compressed weight operand. For a nonzero-valued activation-weight pair, the sparsity accelerator 360 may determine a position the activation in the compressed input operand and determine a position of the weight in the compressed weight operand based on the activation bitmap, weight bitmap, and the combined bitmap. The activation and weight can be read from the local memory 340 based on the positions determined by the sparsity accelerator 360.

In some embodiments, the sparsity accelerator 360 includes a sparsity acceleration logic that can compute position bitmaps based on the activation bitmap and weight bitmap. The sparsity accelerator 360 may determine position indexes of the activation and weight based on the position bitmaps. In an example, the position index of the activation in the compressed input operand may equal the number of one(s) in an activation position bitmap generated by the sparsity accelerator 360, and the position index of the weight in the compressed weight operand may equal the number of one(s) in a weight position bitmap generated by the sparsity accelerator 360. The position index of the activation or weight indicates the position of the activation or weight in the compressed input operand or the compressed weight operand. The sparsity accelerator 360 may read the activation and weight from one or more memories based on their position indexes.

The sparsity accelerator 360 can forward the identified nonzero-valued activation-weight pairs to the PE. The sparsity accelerator 360 may skip the other activations and the other weights, as they will not contribute to the result of the MAC operation. In some embodiments, the local memory 340 may store the nonzero-valued activations and weights and not store the zero-valued activations or weights. The nonzero-valued activations and weights may be loaded to one or more register files of the PE, from which the sparsity accelerator 360 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the input operand and weight operand.

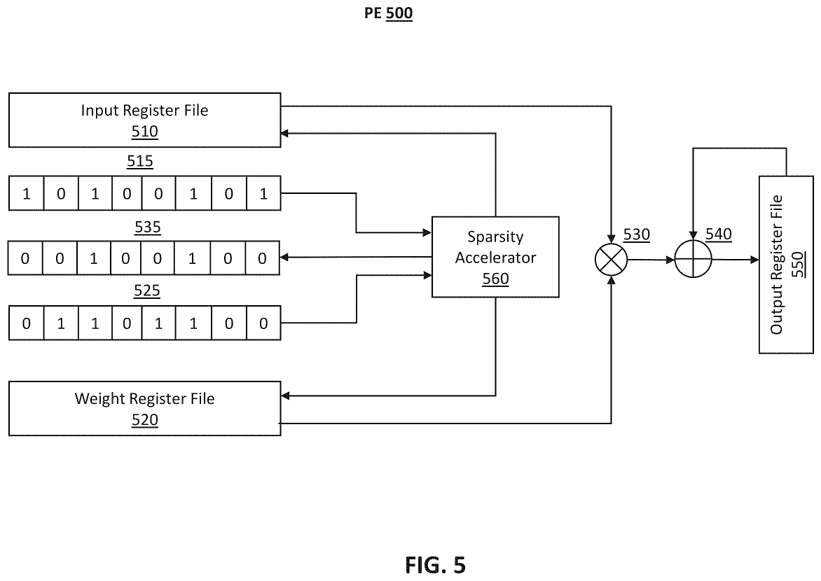

The sparsity accelerator 360 may be implemented in hardware, software, firmware, or some combination thereof. In some embodiments, at least part of the sparsity accelerator 360 may be inside a PE. Even though FIG. 3 shows a single sparsity accelerator 360, the compute block 330 may include multiple sparsity accelerators 360. In some embodiments, every PE in the PE array 350 is implemented with a sparsity accelerator 360 for accelerating computation and reducing power consumption in the individual PE. In other embodiments, a subset of the PE array 350 (e.g., a PE column or multiple PE columns in the PE array 350) may be implemented with a sparsity accelerator 360 for acceleration computations in the subset of PEs. More details regarding sparsity acceleration are provided below in conjunction with FIG. 5.

The post processing unit 370 processes outputs of the PE array 350. In some embodiments, the post processing unit 370 computes activation functions. The post processing unit 370 may receive outputs of the PE array 350 as inputs to the activation functions. The post processing unit 370 may transmit the outputs of the activation functions to the local memory 340. The outputs of the activation functions may be retrieved later by the PE array 350 from the local memory 340 for further computation. For instance, the post processing unit 370 may receive an output tensor of a DNN layer from the PE array 350 and computes one or more activation functions on the output tensor. The results of the computation by the post processing unit 370 may be stored in the local memory 340 and later used as input tensor of the next DNN layer. In addition or alternative to activation functions, the post processing unit 370 may perform other types of post processing on outputs of the PE array 350. For instance, the post processing unit 370 may apply a bias on an output of the PE array 350.

The sparsity encoder 380 converts dense data to compressed data based on sparsity in the dense data. The sparsity encoder 380 may execute pruning operations, such as activation pruning operations or weight pruning operations. The sparsity encoder 380 may also generate sparsity bitmaps, including activation bitmaps and weight bitmaps, based on the pruning operations.

In some embodiments, the sparsity encoder 380 may receive an output tensor (e.g., the output tensor 230 in FIG. 2) of a layer. The sparsity encoder 380 may generate a compressed version of the output tensor. In some embodiments, the sparsity encoder 380 may compress the output tensor based on an activation threshold. The sparsity encoder 380 may compare each activation with the activation threshold. The sparsity encoder 380 may output zero when the absolute value of the activation is lower than the activation threshold but output the value of the activation when the absolute value of the activation is greater than or equal to the activation threshold. The nonzero-valued outputs of the sparsity encoder 380 (i.e., the activations having absolute values greater than or equal to the activation threshold) are stored in memory, e.g., the local memory 340, and may be used in an operation in the next layer. The other activations may not be stored. The sparsity encoder 380 may also generate one or more sparsity bitmaps of the output tensor. A sparsity bitmap may correspond to a vector (e.g., the vector 235 in FIG. 2) in the output tensor. The sparsity map may include bits, each of which corresponds to a different activation in the vector and indicates whether the corresponding activation is zeroed or not.

In some embodiments, the sparsity encoder 380 may compress weight tensors. For instance, the sparsity encoder 380 may prune a kernel of a layer based on a weight threshold. The sparsity encoder 380 may compare each weight with the weight threshold. The sparsity encoder 380 may output zero when the absolute value of the weight is lower than the weight threshold but output the value of the weight when the absolute value of the weight is greater than or equal to the weight threshold. The nonzero-valued outputs of the sparsity encoder 380 (i.e., the weights having absolute values greater than or equal to the weight threshold) are stored in memory, e.g., the local memory 340, and may be used in an operation in the next layer. The other weights may not be stored. The sparsity encoder 380 may also generate one or more sparsity bitmaps of the weight tensor. A sparsity bitmap may correspond to a weight operand (e.g., the weight operand 227 in FIG. 2) in the weight tensor. The sparsity map may include bits, each of which corresponds to a different weight in the vector and indicates whether the corresponding weight is zeroed or not.

In some embodiments, the local memory 340 is associated with a load path and a drain path may be used for data transfer within the compute block 330. For instance, data may be transferred from the local memory 340 to the PE array 350 through the load path. Data may be transferred from the PE array 350 to the local memory 340 through the drain path. The sparsity encoder 380 may be arranged on the drain path for compressing data before the data is written into the local memory 340.

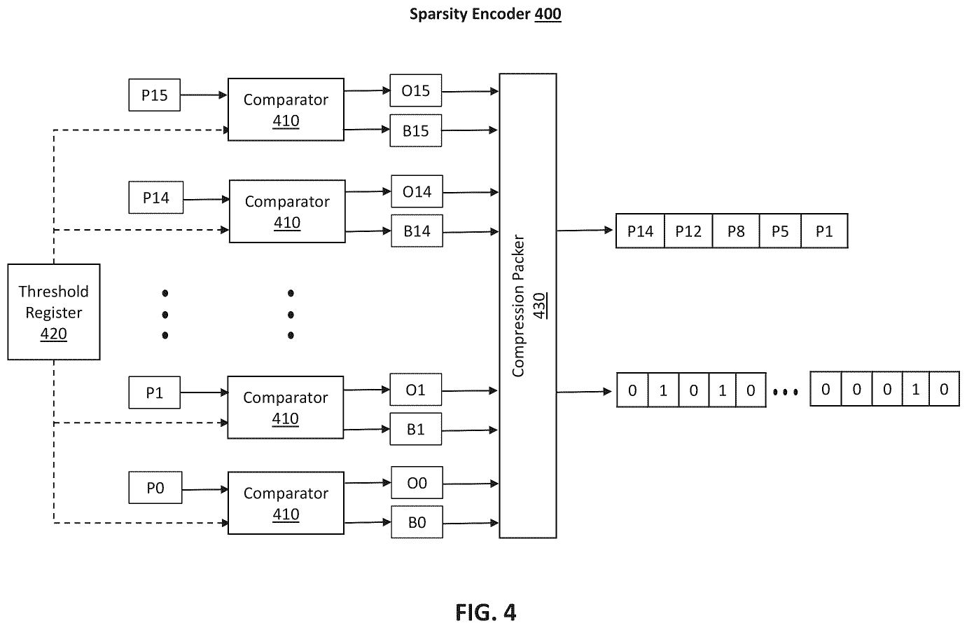

FIG. 4 illustrates a pruning operation by a sparsity encoder 400, in accordance with various embodiments. The sparsity encoder 400 may be an embodiment of the sparsity encoder 380 in FIG. 3. As shown in FIG. 4, the sparsity encoder 400 includes comparators 410 (individually referred to as “comparator 410”), a threshold register 420, and a compression packer 430. In other embodiments, the sparsity encoder 400 may include different, fewer, or more components. Further, functionality attributed to a component of the sparsity encoder 400 may be accomplished by a different component of the sparsity encoder 400.

For the purpose of illustration, the pruning operation shown in FIG. 4 is on a vector comprising 16 data elements: P0-P15. An example of the vector may be computed in a layer of a DNN and may be a result of a deep learning operation in the layer. Another example of the vector may be a portion of a weight tensor of a DNN layer. Each comparator 410 receives a data element and compares the absolute value of the data element with a threshold stored in the threshold register 420. The threshold may be predetermined by the DNN module 301. In some embodiments, the threshold may be zero. In other embodiments, the threshold may be a positive number. The comparators 410 outputs 16 data elements O0-O15 and 16 bits B0-B14. When the absolute value of the data element received by a comparator 410 is lower than the threshold, the comparator 410 may output a zero-valued data element of zero and a zero-valued bit. When the absolute value of the data element received by a comparator 410 is not lower than the threshold, the comparator 410 may output the data element that it received and output a one-valued bit.

The compression packer 430 receives the data elements O0-O15 and bits B0-B14 from the comparators 410. The compression packer 430 generates a new vector that includes the nonzero-valued outputs of the comparator 410. The new vector is a compressed version of the vector received by the sparsity encoder 400. For the purpose of illustration, the new vector in FIG. 4 includes five data elements: P1, P5, P8, P12, and P14. In lieu of storing and computing all the 16 data elements, the five data elements in the new vector are stored and computed and therefore, memory usage and power usage can be reduced.

The compression packer 430 also generates a sparsity bitmap that includes the 16 bits B0-B14. Each bit in the sparsity bitmap corresponds to a different one of the 16 data elements P0-P15. For instance, B0 corresponds to P0, B1 corresponds to P1, B2 corresponds to P2, and so on. Each bit may indicate whether the corresponding data element is to be provided to a PE for computation or is to be skipped from computation. In the embodiments of FIG. 4, a zero-valued bit indicates that the corresponding data element is not to be provided to any PE for computation, while a one-valued bit indicates that the corresponding data element is to be provided to one or more PEs for computation. For instance, the bit B0 indicates that the data element P0 is to be skipped from computation, versus the bit B1 indicates that the data element P1 is to be provided to one or more PEs for computation. The new vector and sparsity bitmap may be stored in memory, e.g., the local memory 340.

FIG. 5 illustrates sparsity acceleration in an MAC operation by a PE 500, in accordance with various embodiments. The PE 500 may be a PE in the PE array 440. In the embodiments of FIG. 5, the PE 500 includes an input register file 510, a weight register file 520, a multiplier 530, an accumulator 540, and an output register file 550. In other embodiments, the PE 500 may include fewer, more, or different components. The PE 500 is associated with a sparsity accelerator 560. The sparsity accelerator 560 may be an embodiment of the sparsity accelerator 360 in FIG. 3.

The input register file 510 stores at least part of an activation operand. The activation operand includes a sequence of input elements, aka activations. The activation operand may be a portion of an input tensor, e.g., an input tensor of a convolutional layer. The activation operand is associated with an activation bitmap 515. The activation bitmap 515 may be stored in the input register file 510, the local memory of the compute block that includes the PE 500, or both. The activation bitmap 515 can indicate positions of the nonzero-valued activations in the activation operand. The activation bitmap 515 includes a sequence of bits, each of which corresponds to a respective activation in the activation operand. In some embodiments, the position of a bit in the activation bitmap 515 matches the position of the corresponding activation in the activation operand. For the purpose of illustration, the activation bitmap 515 includes eight bits, and the activation operand includes eight activations. In other embodiments, the activation bitmap 515 may include fewer or more bits. As shown in FIG. 5, four of the eight bits in the activation bitmap 515 are zero valued, and the other four bits are one-valued. A zero-valued bit indicates that the value of the corresponding activation is zero, a one-valued bit indicates that the value of the corresponding activation is nonzero. Accordingly, the activation operand includes four zero-valued activations and four nonzero-valued activations.

The weight register file 520 stores at least part of a weight operand. The weight operand includes a sequence of weights. The weight operand may be a portion of a filter, e.g., a filter of a convolutional layer. The weight operand is associated with a weight bitmap 525. The weight bitmap 525 may be stored in the weight register file 520, the local memory of the compute block that includes the PE 500, or both. The weight bitmap 525 can indicate positions of the nonzero-valued weights in the weight operand. The weight bitmap 525 includes a sequence of bits, each of which corresponds to a respective weight in the weight operand. In some embodiments, the position of a bit in the weight bitmap 525 matches the position of the corresponding weight in the weight operand. For the purpose of illustration, the weight bitmap 525 includes eight bits, and the weight operand includes eight weights. In other embodiments, the weight bitmap 525 may include fewer or more bits. As shown in FIG. 5, four of the eight bits in the weight bitmap 525 are zero valued, and the other four bits are one-valued. A zero-valued bit indicates that the value of the corresponding weight is zero, a one-valued bit indicates that the value of the corresponding weight is nonzero. Accordingly, the weight operand includes four zero-valued weights and four nonzero-valued weights. The weight bitmap 525 can indicate positions of the nonzero-valued weights in the weight operand.

The sparsity accelerator 560 generates a combined sparsity bitmap 535 based on the activation bitmap 515 and the weight bitmap 525. The sparsity accelerator 560 may receive the activation bitmap 515 from the input register file 510 or the local memory of the compute block that includes the PE 500. The sparsity accelerator 560 may receive the weight bitmap 525 from the weight register file 520 or the local memory of the compute block. In some embodiments, the sparsity accelerator 560 is an AND operator. The sparsity accelerator 560 may generate the combined sparsity bitmap 535 by performing one or more AND operations on the activation bitmap 515 and the weight bitmap 525. Each bit in the combined sparsity bitmap 535 is a result of an AND operation on a bit in the activation bitmap 515 and a bit in the weight bitmap 525. The position of the bit in the combined sparsity bitmap 535 matches the position of the bit in the activation bitmap 515 and the position of the bit in the weight bitmap 525. For instance, the first bit in the combined sparsity bitmap 535 is a result of an AND operation on the first bit in the activation bitmap 515 and the first bit in the weight bitmap 525, the second bit in the combined sparsity bitmap 535 is a result of an AND operation on the second bit in the activation bitmap 515 and the second bit in the weight bitmap 525, the third bit in the combined sparsity bitmap 535 is a result of an AND operation on the third bit in the activation bitmap 515 and the third bit in the weight bitmap 525, and so on.

A bit in the combined sparsity bitmap 535 has a value of one when the corresponding bit in the activation bitmap 515 and the corresponding bit in the weight bitmap 525 both have values of one. When at least one of the corresponding bits in the activation bitmap 515 and the corresponding bit in the weight bitmap 525 has a value of zero, the bit in the combined sparsity bitmap 535 has a value of zero. As shown in FIG. 5, the combined sparsity bitmap 535 includes six zeros and two ones.

The total number of ones in the combined sparsity bitmap 535 equals the total number of nonzero-valued activation-weight pairs that will be computed by the PE 500 to compute nonzero-valued partial sums. The other activation-weight pairs are zero-valued activation-weight pairs and can be skipped for computation without any impact on the output accuracy, as these pairs will result in zero-valued partial sums. Accordingly, the workload of the PE 500 in this compute round can be determined based on the total number of ones in the combined sparsity bitmap 535. The amount of time for the computation can also be estimated based on the total number of ones in the combined sparsity bitmap 535. The more ones in the combined sparsity bitmap 535, the higher the workload of the PE 500, and the longer the computation of the PE 500.

In some embodiments, the input register file 510 or the weight register file 520 stores dense data points, e.g., nonzero-valued activations or nonzero-valued weights. The sparse data points, e.g., zero-valued activations or zero-valued weights, are not stored in the input register file 510 or the weight register file 520. The dense data points may be compressed and kept adjacent to each other in the input register file 510 or the weight register file 520. The dense data point(s) of an activation operand is a compressed activation operand. The dense data point(s) of a weight operand constitutes a compressed weight operand. The position of the ones in the combined sparsity bitmap 535 cannot indicate the positions of the activations in the compressed activation operand or the positions of the weights in the compressed weight operand. The sparsity accelerator 560 may perform sparsity computations to determine the positions of the activations in the compressed activation operand and the positions of the weights in the compressed weight operand. The sparsity accelerator 560 may perform a round of sparsity computation for each of the two nonzero-valued activation-weight pairs. In each round of sparsity computation, the sparsity accelerator 560 may compute an activation position bitmap and a weight position bitmap based on the activation bitmap 515, the weight bitmap 525, and the combined sparsity bitmap 535. The position of the activation in the compressed activation operand may be indicated by the number of ones in the activation position bitmap, and the position of the weight in the compressed weight operand may be indicated by the number of ones in the weight position bitmap. In the first round of sparsity computation, an intermediate bitmap may be determined and can be used in the second round to identify the next nonzero-valued activation-weight pair.

The sparsity accelerator 560 can read, from the input register file 510 and the weight register file 520, the activations and weights of the nonzero-valued activation-weight pairs based on the positions determined through the sparsity computations and provides the activations and weights to the multiplier 530. The multiplier 530 performs multiplication operations on the activations and weights. For instance, the multiplier 530 performs a multiplication operation on the activation and weight in each nonzero-valued activation-weight individual pair and outputs a partial sum, i.e., a product of the activation and weight. As there are two activation-weight pairs, the multiplier 530 may perform two multiplication operations sequentially, e.g., based on the positions of the ones in the combined sparsity bitmaps 535. Without the sparsity acceleration, the multiplier 530 would need to perform eight multiplication operations. By reducing the number of multiplication operations from eight to two, the MAC operation in the PE 500 is accelerated. As a DNN accelerator usually performs a large number of MAC operations in the execution of a DNN, the sparsity acceleration can significantly improve the efficiency and performance of the DNN accelerator.

The accumulator 540 receives the two partial sums from the multiplier 530 and accumulates the two partial sums. The result of the accumulation is a PE-level internal partial sum. The PE-level internal partial sum may be stored in the output register file 550. In some embodiments, the accumulator 540 receives one or more PE-level internal partial sums from one or more other PEs. The accumulator 540 can accumulate the one or more PE-level internal partial sums with the PE-level internal partial sum of the PE 500 and store the result of the accumulation (i.e., a multi-PE internal partial sum) in the output register file 550. The one or more other PEs may be in the same column as the PE 500 in a PE array. The multi-PE internal partial sum may be a column-level internal partial sum. In some embodiments, the PE-level internal partial sum of the PE 500 or the multi-PE internal partial sum may be sent to one or more other PEs for further accumulation.

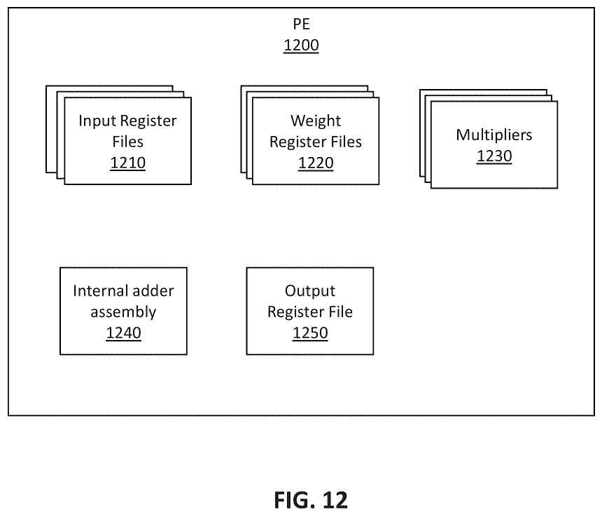

Even though FIG. 5 shows a single multiplier 530, the PE 500 may include multiple multipliers that can perform multiple multiplication operations at the same time. These multipliers can be coupled to an internal adder assembly, e.g., the internal adder assembly 1240 in FIG. 12.

FIG. 6 is a block diagram of a DNN module 600, in accordance with various embodiments. The DNN module 600 may be an embodiment of the DNN module 301 in FIG. 3. As shown in FIG. 6, the DNN module 600 includes an interface module 610, a training module 620, a compressing module 630, a validating module 640, and a datastore 650. In other embodiments, alternative configurations, different or additional components may be included in the DNN module 600. Further, functionality attributed to a component of the DNN module 600 may be accomplished by a different component included in the DNN module 600 or a different module or system.

The interface module 610 facilitates communications of the DNN module 600 with other modules or systems. For example, the interface module 610 establishes communications between the DNN module 600 with an external database to receive data that can be used to train DNNs or input into DNNs to perform tasks. As another example, the interface module 610 supports the DNN module 600 to distribute DNNs to other systems, e.g., computing devices configured to apply DNNs to perform tasks.

The training module 620 trains DNNs by using a training dataset. The training module 620 forms the training dataset. In an embodiment where the training module 620 trains an

DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 640 to validate performance of a trained DNN. The portion of the training dataset not including the tuning subset and the validation subset may be used to train the DNN.

The training module 620 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 5, 10, 50, 100, 500, 1000, or even larger.

The training module 620 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, SoftMax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 620 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 620 defines the architecture of the DNN, the training module 620 inputs a training dataset into the DNN. The training dataset includes a plurality of training samples. An example of a training sample includes an object in an image and a ground-truth label of the object. The training module 620 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 620 uses a cost function to minimize the error.

The training module 620 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 620 finishes the predetermined number of epochs, the training module 620 may stop updating the parameters in the DNN. The DNN having the updated parameters is referred to as a trained DNN.

The compressing module 630 compresses DNNs. For instance, the compressing module 630 may add pruning operations to DNN layers to reduce computational complexity or memory usage. A pruning operation may be an activation pruning operation or weight pruning operation. Activation pruning operations may prune output tensors of DNN layers. Weight pruning operations may prune weight tensors of DNN layers. In some embodiments, the compressing module 630 may select one or more computationally complex layers in a DNN and modify each selected layer with an activation pruning operation or weight pruning operation.

For a pruning operation of a layer or of a type of layer, the compressing module 630 may determine an activation threshold or a weight threshold that would not cause a loss of the accuracy of the DNN to exceed an accuracy loss constraint. An activation pruning operation may modify output activations having absolute values below the activation threshold to zeros and leave the other output activations of the layer unchanged. Reducing the output data can reduce memory traffic as zero-valued activations may be skipped from memory storage. It can also reduce the number of operations in the next layer as zero-valued activations may also be skipped from computation.

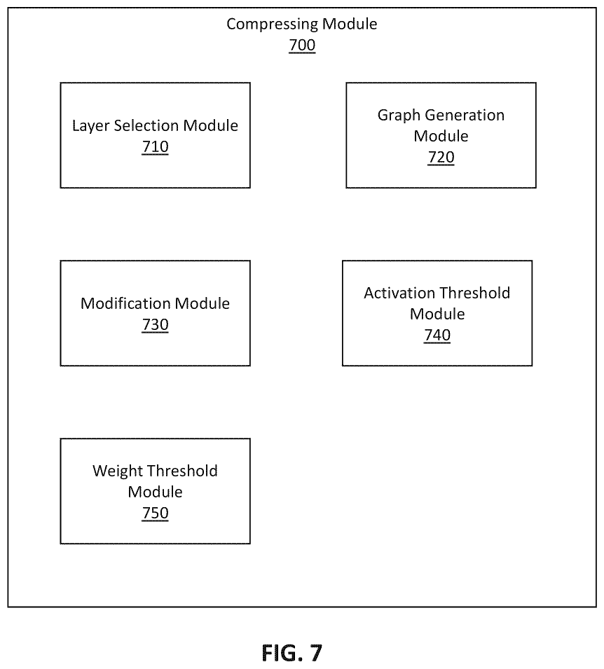

A weight pruning operation may modify weights having absolute values above the weight threshold to zeros and leave the other weights unchanged. The weight pruning can reduce memory storage as zero-valued weights may not be stored. Also, the number of operations in the layer can be reduced as computations on zero-valued weights can be skipped without impacting the output of the layer. In some embodiments, the compressing module 700 may also measure energy saving, final DNN accuracy, or layer-wise sparsity caused by pruning operations. Certain aspects of the compressing module 630 are provided below in conjunction with FIG. 7.

After compressing a DNN, the compressing module 630 may fine tune the DNN, e.g., through a retraining process. The compressing module 630 may fine tunes DNNs after weights are pruned. In some embodiments, the fine-tuning process is a retraining or further training process. For instance, after weights in a DNN are pruned, the compressing module 630 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the compressing module 630 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the compressing module 630, the compressing module 630 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 4, 5, etc.

The validating module 640 verifies accuracy of trained or compressed DNNs. In some embodiments, the validating module 640 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validating module 640 may determine an accuracy score measuring the precision, recall, or a combination of precision and recall of the DNN. The validating module 640 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validating module 640 may compare the accuracy score with a threshold score. In an example where the validating module 640 determines that the accuracy score of the augmented model is less than the threshold score, the validating module 640 instructs the training module 620 to re-train the DNN. In one embodiment, the training module 620 may iteratively re-train the DNN until the occurrence of a stopping condition, such as the accuracy measurement indication that the DNN may be sufficiently accurate, or a number of training rounds having taken place.

The datastore 650 stores data received, generated, used, or otherwise associated with the DNN module 600. For example, the datastore 650 stores the datasets used by the training module 620 and validating module 640. The datastore 650 may also store data generated by the training module 620 and validating module 640, such as the hyperparameters for training DNNs, internal parameters of trained DNNs (e.g., weights, etc.), data for sparsity acceleration (e.g., sparsity bitmap, etc.), and so on. In the embodiment of FIG. 6, the datastore 650 is a component of the DNN module 600. In other embodiments, the datastore 650 may be external to the DNN module 600 and communicate with the DNN module 600 through a network.

FIG. 7 is a block diagram of a compressing module 700, in accordance with various embodiments. The compressing module 700 may be an embodiment of the compressing module 630 in FIG. 6. As shown in FIG. 7, the compressing module 700 includes a layer selection module 710, a graph generation module 720, a modification module 730, an activation threshold module 740, and a weight threshold module 750. In other embodiments, alternative configurations, different or additional components may be included in the compressing module 700. Further, functionality attributed to a component of the compressing module 700 may be accomplished by a different component included in the compressing module 700, the DNN module 600, or a different module or system.

The layer selection module 710 analyzes DNNs and selects layers from the DNNs for being modified with pruning operations. In some embodiments, the layer selection module 710 may select one or more computationally complex layers from a DNN. A computationally complex layer may be computation intensive or memory intensive. Pruning activations or weights of the layer may reduce the computational or memory resources needed for executing the layer.

In some embodiments, the layer selection module 710 may select a layer to which an activation pruning operation is to be added and select a different layer to which a weight pruning operation is to be added. The layer selection module 710 may also select a layer to which both an activation pruning operation and a weight pruning operation are to be added. In some embodiments, the layer selection module 710 may exclude last layers of DNNs from being selected for modification, e.g., a last layer that may output the final class probability after SoftMax operation and are not compute heavy.

In some embodiments, the layer selection module 710 may identify computationally complex layers in DNNs and select these layers as layers to be modified. The layer selection module 710 may determine that a layer is computationally complex based on one or more attributes of the layer, such as the size of the layer, the number of operations (e.g., MAC operations) in the layer, the type of the layer, special operation present before the layer, or other attributes of the layer.

The layer selection module 710 may determine the size of a layer based on the number of internal parameters (e.g., weights) of the layer. The layer selection module 710 may determine the number of operations in the layer based on hyperparameters of the layer, such as the size of a tensor (e.g., input tensor, weight tensor, output tensor, etc.) of the layer, padding size, stride size, and so on. The layer selection module 710 may determine that layers of particular types are computationally complex. Examples of such layers may include convolution layers, nonlinear attention layers (e.g., ReLU, GELU, etc.), activation layers, normalization layers, elementwise operation layers (add, subtract, multiply, divide, etc.), and feedforward layers. The layer selection module 710 may select a layer having one or more operations before the layer. Examples of such special operations may include transpose, reshape, concatenate, and so on.

The graph generation module 720 generates graphs representing DNNs. A graph may be a data structure comprising a collection of nodes and one or more edges. A node is an entity in the graph, and an edge is a connection of two nodes. A graph may be associated with one or more embeddings. For instance, the graph may have a graph embedding that encodes one or more characteristics of the graph, a node in the graph may have a node embedding that encodes one or more characteristics of the node, or an edge in the graph may have an edge embedding that encodes one or more characteristics of the edge. An embedding may be a vector, which is also referred to as embedding vector.

A node in a graph representing a DNN may represent a deep learning operation or a layer of the DNN. The node may be connected to another node representing another deep learning operation or another layer in the DNN. The edge between the two nodes may encode the data flow between the two layers. In some embodiments, the edge may encode a tensor, such as the output tensor of the first layer or the input tensor of the second layer. A node or an edge may also encode special operations before or after the corresponding layer, such as transpose, reshape, concatenate, and so on. In some embodiments, the nodes in the graph may be arranged based on the DNN's forward execution pass. For instance, the nodes may be arranged in an order that matches the order of the layers represented by the nodes in the DNN. The graph can facilitate model manipulation and analysis of statistics of intermediate activation is easier without access to the model's source code.

In some embodiments, the graph generation module 720 may also optimize the graph for inference. For example, multiple layers (e.g., convolutional layers) may be fused together. may be fused. As another example, normalization layers may be batched. The optimization may be done to mimic the inference execution in DNN accelerators, e.g., the DNN accelerator 302. The graph generation module 720 may also eliminate dropout layers as these layers may be ineffective during inference. The graph generation module 720 may perform other types of optimizations. The optimization can reduce latency, improve performance of the DNN accelerator, or reduce memory usage.

The modification module 730 modifies layers selected by the layer selection module 710 with pruning operations. In some embodiments, layer modification may be done through a graph generated by the graph generation module 720 for representing the DNN. The modification module 730 may identify a position of a selected layer in the DNN based on the graph representing the DNN. After the position of the selected layer is identified, the modification module 730 may add a pruning operation to the identified position or to a position that is before or after the identified position.

The modification module 730 may add at least one pruning operation to each selected layer. For example, the modification module 730 may add an activation pruning operation to a selected layer so that the activation pruning operation can prune output activations of the layer. The modification module 730 may place the activation pruning operation after the selected layer. As another example, the modification module 730 may add a weight pruning operation to a selected layer so that the weight pruning operation can prune weights of the layer. As yet another example, the modification module 730 may add both an activation pruning operation and a weight pruning operation to a selected layer. An activation pruning operation may be denoted as:

$${act}_{l}^{′} = {Threshold}_{{λ}_{l}} ( a c {t}_{l} ) = \{ \begin{matrix}{act}_{l} , if \vert {act}_{l} \vert > {λ}_{l} \\ 0 , if \vert {act}_{l} \vert \leq {λ}_{l}\end{matrix}$$

where l denotes the layer where the activation pruning operation is placed, actₗ denotes output activations of the layer, act′ₗ denotes pruned output activations determined by the activation pruning operation, and λₗ denotes the activation threshold used by the activation pruning operation to prune activations. The activation pruning operation does not change the value of an activation that has an absolute value above the activation threshold but changes the value of an activation having an absolute value below the activation threshold to zero. A weight pruning operation may be denoted as:

$${w}_{l}^{′} = \{ \begin{matrix}0 , \vert {w}_{l} \vert < {λ}_{l} \\ {w}_{l} , \vert {w}_{l} \vert \geq {λ}_{l}\end{matrix}$$

where l denotes the layer where the activation pruning operation is placed, wᵢ denotes weights of the layer, w′ᵢ denotes pruned weights output from the activation pruning operation, and λₗ denotes the weight threshold used by the weight pruning operation to prune weight. The weight pruning operation does not change the value of a weight that has an absolute value above the weight threshold but changes the value of a weight having an absolute value below the weight threshold to zero. A pruning operation (either activation pruning operation or weight pruning operation) may be executed using one or more sparsity encoders, such as the sparsity encoder 380 in FIG. 3. The weight pruning operation, in some embodiments, may be performed in the compilation stage as the values of the weights are predetermined through training the DNN. The weights may be pruned using the weight threshold before the weights are loaded to the DNN accelerator, which can eliminate the area and power overhead to the DNN accelerator caused by the weight pruning operation.

The activation threshold module 740 determines activation thresholds for activation pruning operations. In some embodiments, the activation threshold module 740 may select an optimal activation threshold (e.g., from a plurality of candidate activation thresholds) for an activation pruning operation through an iterative process based on an accuracy loss constraint. The optimal activation threshold may be the highest candidate activation threshold that would not cause the loss of the DNN's accuracy exceeds the accuracy loss constraint. The accuracy loss constraint may be a maximum threshold for accuracy loss. Accuracy loss may be the difference between the accuracy of the DNN with the activation pruning operation and the baseline accuracy of the DNN. The baseline accuracy of the DNN may be the accuracy of the DNN without the activation pruning operation.

In some embodiments, the accuracy loss may be denoted as:

ΔA=(Acc_{baseline}−Acc_{threshold})<A_{b}

where Acc_{baseline} denotes the baseline accuracy of the DNN, Top1Acc_{threshold} denotes the accuracy of the DNN with the activation pruning operation that uses the activation threshold to prune activations, and A_{b} denotes the accuracy loss constraint. The baseline accuracy and the accuracy loss constraint may be predetermined. In some embodiments, Top 1 accuracy is used. Top 1 accuracy may indicate the proportion (e.g., percentage) of inputs for which the labels generated by the DNN match the ground-truth labels of the inputs. A_{b} may be 0.5%, 1%, 1.5%, 2%, 2.5%, and so on.

Different layers may have different tolerance to pruning so that the accuracy loss may be different even though the activations of the layers are pruned with the same activation threshold. The activation threshold module 740 may determine layer-specific activation thresholds. In an example, the activation threshold module 740 may determine an activation threshold specific to a particular type of layer. Different types of layers may have different activation thresholds.

In some embodiments, the iterative process may include a plurality of rounds. In each round, the activation pruning operation may be done using a different candidate threshold. The threshold used in the first round may be the smallest one, e.g., zero. The threshold for each subsequent round may be determined by incrementing the threshold of the previous round. The increment may be fixed in some embodiments.

In each round, the activation threshold module 740 may determine (or instruct the validating module 640 to determine) the accuracy of the DNN with the activation pruning operation. To determine the accuracy of the DNN, a dataset may be input into the DNN. The dataset may be a training dataset, validation dataset, or a different dataset. Inference of the DNN is carried out. The outputs of the DNN may be compared with ground-truth outputs of the DNN to determine the accuracy of the DNN. An accuracy loss is determined and compared with the accuracy loss constraint. In embodiments where the accuracy loss is lower than the accuracy loss constraint, the next round will be carried out with a higher activation threshold. In embodiments where the accuracy loss is greater than or equal to the accuracy loss constraint, the iterative process will stop, and the threshold used in the previous round will be selected as the optimal activation threshold for the layer. The optimal activation threshold may be stored in an internal register integrated with one or more sparsity encoders (e.g., the sparsity encoder 380), e.g., during inference run-time. The sparsity encoder can use the optimal activation threshold to prune activations generated by the layer and provide the pruned activations to the next layer.

The weight threshold module 750 determines weight thresholds for weight pruning operations. In some embodiments, the weight threshold module 750 may determine an optimal weight threshold (e.g., from a plurality of candidate weight thresholds) for a weight pruning operation based on an accuracy loss constraint, a minimum constraint, and a maximum constraint. The accuracy loss constraint may be the accuracy loss constraint described above. The minimum constraint and maximum constraint may constitute constraints of the optimal weight threshold, e.g., the optimal weight threshold may be greater than the minimum constraint and lower than the maximum constraint.

In some embodiments, the weight threshold module 750 determines the minimum value of the absolute weights. The absolute weights may be the absolute values of the weights in a kernel of the layer. The minimum value may be the minimum absolute value of the weights. In embodiments where the minimum value is higher than the minimum constraint, the weight threshold module 750 sets zeros as the optimal weight threshold for the layer to avoid introducing sparsity to the layer.

In embodiments where the minimum value is lower than or equal to the minimum constraint, the weight threshold module 750 may determine a nonzero-valued optimal weight threshold, e.g., through an iterative process in which the maximum constraint may be incremented for each subsequent round. The increment of the maximum constraint may be a fixed value that is predetermined. The weight threshold module 750 may compute one or more quantiles from the distribution of the absolute weights. A quantile may determine how many values in a distribution that are above or below a certain limit. In an example, the weight threshold module 750 may compute 0.1, 0.2, 0.3, 0.4, 0.5, 0.6, 0.7. 0.8, and 0.9 quantiles, which may be equivalent to 10^{th}, 20^{th}, 30^{th}, 40^{th}, 50^{th}, 60^{th}, 70^{th}, 80^{th}, and 90^{th} percentile. In each round of the iterative process, the weight threshold module 750 may identify the highest quantile that is lower than the maximum constraint.

The weight threshold module 750 may further compare the identified quantile with the minimum constraint. The weight threshold module 750 may select the higher one of the identified quantile and the minimum constraint as the weight threshold for the round. The weight threshold module 750 may further determine (or instruct the validating module 640 to determine) the accuracy of the DNN with the weight pruning operation using the weight threshold to prune weights. To determine the accuracy of the DNN, a dataset may be input into the DNN. The dataset may be a training dataset, validation dataset, or a different dataset. Inference of the DNN is carried out. The outputs of the DNN may be compared with ground-truth outputs of the DNN to determine the accuracy of the DNN. An accuracy loss is determined and compared with the accuracy loss constraint. In embodiments where the accuracy loss is greater than or equal to the accuracy loss constraint, the iterative process will stop, and the threshold used in the previous round will be selected and stored as the optimal activation threshold for the layer.

In embodiments where the accuracy loss is lower than the accuracy loss constraint, the next round will be carried out with a higher maximum constraint. With the higher maximum constraint, the weight threshold module 750 may identify a new highest quantile of the absolute weights that is lower than the higher maximum constraint. The weight threshold module 750 may repeat the step of comparing the highest quantile with the minimum constraint to select which one to use as the weight threshold of the round and the step of checking accuracy loss to determine whether to stop the iterative process or to carry out the next round.

In some embodiments (e.g., embodiments a layer is modified with both activation pruning operation and weight pruning operation), the activation threshold module 740 and the weight threshold module 750 may operate in a sequence. In an embodiment, the weight threshold module 750 may determine the optimal weight threshold for the layer before the activation threshold module 740 determines the optimal activation threshold. The baseline DNN accuracy used by the activation threshold module 740 may be the accuracy of the DNN with the weight pruning operation using the optimal weight threshold found by the weight threshold module 750. In another embodiment, the activation threshold module 740 determines the optimal activation threshold before the weight threshold module 750 may determine the optimal weight threshold for the layer. The baseline DNN accuracy used by the weight threshold module 750 may be the accuracy of the DNN with the activation pruning operation using the optimal activation threshold found by the activation threshold module 740.

Example Processes of Selecting Optimal Thresholds

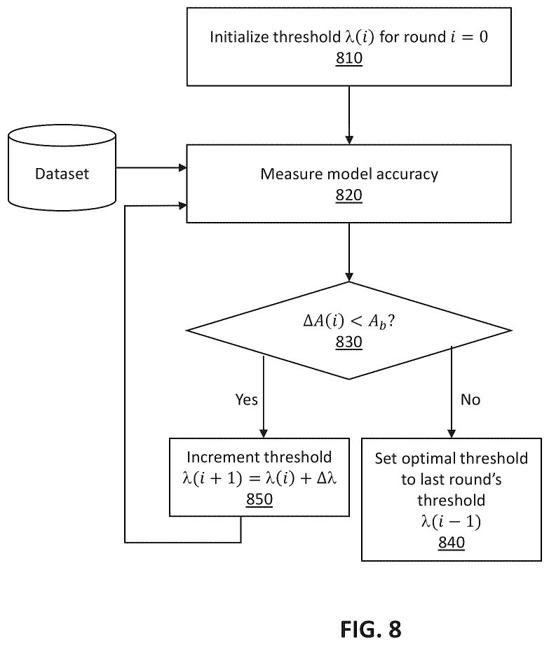

FIG. 8 illustrates selection of an optimal threshold for pruning activations, in accordance with various embodiments. The selection of the optimal threshold may be performed by the activation threshold module 740 in FIG. 7. In Step 810 shown in FIG. 8, a threshold λ is initialized for the first round, i.e., the round with round index i=0. The threshold λ may be zero or a positive number.

In Step 820, model accuracy is measured using a dataset. The dataset may be generated by the training module 620 or the validating module 640. The dataset may include one or more inputs to the DNN, each input may be associated with one or more ground-truth labels. The model accuracy may be determined by comparing the labels of the inputs that are generated by the DNN with the ground-truth labels of the inputs. In some embodiments, the model accuracy may be a percentage indicating how many labels generated by the DNN match the corresponding ground-truth labels. The model accuracy may be a Top 1 accuracy.

In Step 830, an accuracy loss ΔA(i) is compared with an accuracy loss constraint A_{b}. The accuracy loss ΔA(i) may equal the baseline model accuracy of the DNN minus the model accuracy measured in Step 820. The accuracy loss constraint A_{b} may be predetermined and stored in memory.

When the accuracy loss AA(i) is not lower than the accuracy loss constraint A_{b}, Step 840 is performed. In Step 840, the optimal threshold is set to be the threshold used in the previous round i−1. The optimal threshold may be stored in memory, such as the local memory 340, the threshold register 420, etc. The optimal threshold may be used in an activation pruning operation in a layer for pruning activations generated by the layer. In some embodiments, the optimal threshold may be used in activation pruning operations in multiple layers. These layers may be of the same type.

When the accuracy loss ΔA(i) is lower than the accuracy loss constraint A_{b}, Step 850 is performed. In Step 850, the threshold A is incremented by a predetermined value Δλ. The incremented threshold λ is used in the next round i+1. In the next round, Steps 820 and 830 are performed again. Also, Step 840 or 850 may be performed. This may continue until the optimal threshold is found.

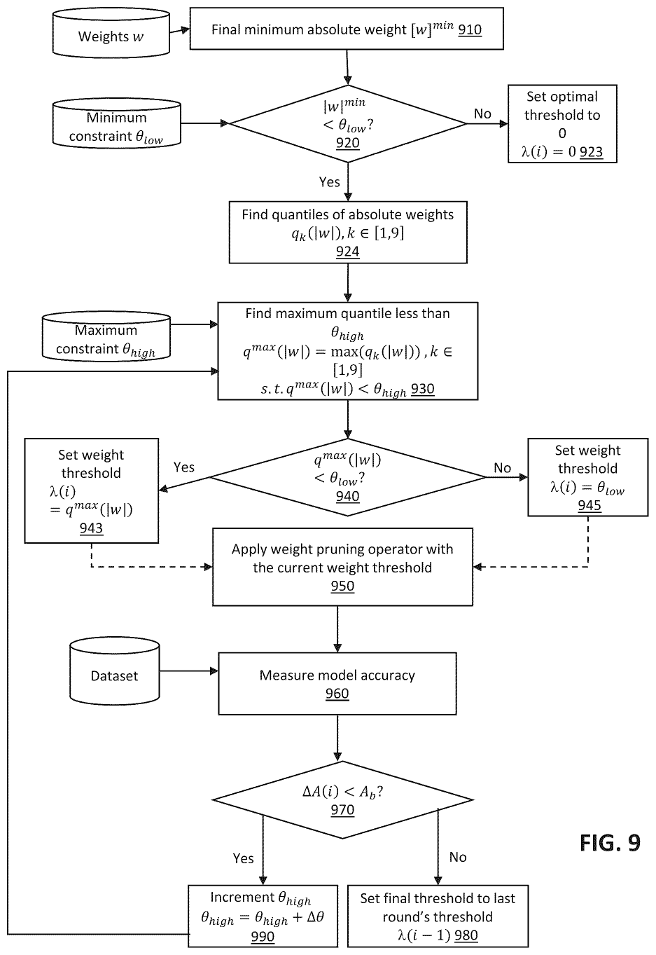

FIG. 9 illustrates selection of an optimal threshold for pruning weights, in accordance with various embodiments. The selection of the optimal threshold may be performed by the weight threshold module 750 in FIG. 7. In Step 910 shown in FIG. 9, the minimum absolute weight w^{min} is found by searching the absolute values of the weights w of a DNN layer. Values of the weights w may be determined by training the DNN.

In Step 920, the minimum absolute weight |w|^{min} is compared with a minimum constraint θ_{low}. When the minimum absolute weight |w|^{min} is not lower than a minimum constraint θ_{low}, Step 923 is performed, and the optimal threshold is set to zero, meaning no additional sparsity is introduced to the weights w of the layer.

When the minimum absolute weight |w|^{min} is lower than a minimum constraint θ_{low}, Step 925 is performed. In Step 925, quantiles qₖ(|w|) of the absolute weights IwI are found. In the embodiments of FIG. 9, nine quantiles are found. The quantiles may be deciles.

In Step 930, the maximum quantile q^{max}(|w|) is found. The maximum quantile q^{max}(|w|) is the quantile having the maximum value that is lower than a maximum constraint θ_{high}, which may be predetermined and stored in memory.

In Step 940, the maximum quantile q^{max}(|w|) is compared with the minimum constraint θ_{low}. When the maximum quantile q^{max}(|w|) is lower than the minimum constraint θ_{low}, Step 943 is performed and the weight threshold of the current round λ(i) is set to the maximum quantile q^{max}(|w|). When the maximum quantile q^{max}(|w|) is not lower than the minimum constraint θ_{low}, Step 945 is performed and the weight threshold of the current round λ(i) is set to the minimum constraint θ_{low}.

In Step 950, the weight pruning operator is applied with the current weight threshold λ(i), i.e., the weight threshold set in Step 943 or 945. The weights having absolute values lower than λ(i) are changed to zeros, and weights having absolute values greater than or equal to λ(i) are not changed.

In Step 960, model accuracy is measured using a dataset. The dataset may be generated by the training module 620 or the validating module 640. The dataset may include one or more inputs to the DNN, each input may be associated with one or more ground-truth labels. The model accuracy may be determined by comparing the labels of the inputs that are generated by the DNN using the pruned weights with the ground-truth labels of the inputs. In some embodiments, the model accuracy may be a percentage indicating how many labels generated by the DNN match the corresponding ground-truth labels. The model accuracy may be a Top 1 accuracy.

In Step 970, an accuracy loss ΔA(i) is compared with an accuracy loss constraint A_{b}. The accuracy loss ΔA(i) may equal the baseline model accuracy of the DNN minus the model accuracy measured in Step 960. The accuracy loss constraint A_{b} may be predetermined and stored in memory.

When the accuracy loss ΔA(i) is not lower than the accuracy loss constraint A_{b}, Step 980 is performed. In Step 980, the optimal threshold is set to be the threshold used in the previous round i−1. The optimal threshold may be stored in memory, such as the local memory 340, the threshold register 420, etc. The optimal threshold may be used in a weight pruning operation in a layer for pruning weights of the layer. In some embodiments, the optimal threshold may be used in weight pruning operations in multiple layers. These layers may be of the same type.

When the accuracy loss ΔA(i) is lower than the accuracy loss constraint A_{b}, Step 990 is performed. In Step 850, the maximum constraint θ_{high} is incremented by a predetermined value Δθ_{high}. The incremented threshold θ_{high} is used in the next round i+1. In the next round, Steps 930, 940, 943 or 945, 950, 960, and 970 are performed again. Also, Step 980 or 990 may be performed. This may continue until the optimal threshold is found.

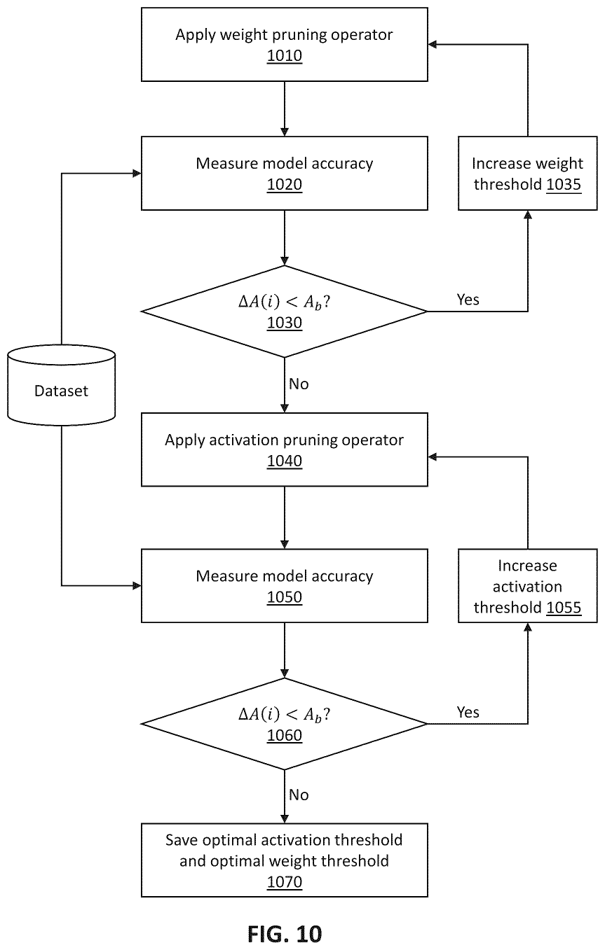

FIG. 10 illustrates selection of optimal thresholds for pruning activations and weights, in accordance with various embodiments. The selection of the optimal thresholds may be performed by the compressing module 700 in FIG. 7. In Step 1010 shown in FIG. 10, a weight pruning operator is applied. The weight pruning operator may be for a weight pruning operation using a programmable weight threshold.

In Step 1020, model accuracy is measured using a dataset. The dataset may be generated by the training module 620 or the validating module 640. The dataset may include one or more inputs to the DNN, each input may be associated with one or more ground-truth labels. The model accuracy may be determined by comparing the labels of the inputs that are generated by the DNN using the pruned weights with the ground-truth labels of the inputs. In some embodiments, the model accuracy may be a percentage indicating how many labels generated by the DNN match the corresponding ground-truth labels. The model accuracy may be a Top 1 accuracy.

In Step 1030, an accuracy loss ΔA(i) is compared with an accuracy loss constraint A_{b}. The accuracy loss ΔA(i) may equal the baseline model accuracy of the DNN minus the model accuracy measured in Step 1020. The accuracy loss constraint A_{b} may be predetermined and stored in memory.

When the accuracy loss ΔA(i) is lower than the accuracy loss constraint A_{b}, Step 1035 is performed, and the weight threshold is increased. Step 1010 is performed again with the increased weight threshold.

When the accuracy loss ΔA(i) is not lower than the accuracy loss constraint A_{b}, the optimal weight threshold can be determined, e.g., the optimal weight threshold may be the weight threshold determined in the previous round.

Step 1040 is then performed. In Step 1040, an activation pruning operator is applied for performing an activation pruning operation with a programmable activation threshold.

In Step 1020, model accuracy is measured using the dataset. In Step 1050, an accuracy loss ΔA(i) is compared with the accuracy loss constraint A_{b}. The accuracy loss ΔA(i) may equal the baseline model accuracy of the DNN minus the model accuracy measured in Step 1030. The baseline model accuracy of the DNN may be an accuracy of the DNN with the weight pruning operation using the optimal weight threshold.

When the accuracy loss ΔA(i) is lower than the accuracy loss constraint A_{b}, Step 1055 is performed, and the activation threshold is increased. Step 1040 is performed again with the increased activation threshold. When the accuracy loss ΔA(i) is not lower than the accuracy loss constraint A_{b}, the optimal activation threshold can be determined, e.g., the optimal activation threshold may be the weight threshold determined in the previous round.

In Step 1070, the optimal weight threshold and optimal activation threshold are set. The optimal weight threshold and optimal activation threshold may be stored in memory, e.g., the local memory 340, the threshold register 420, etc. The optimal weight threshold and optimal activation threshold may be used to prune weights and activations of one or more layers. In the embodiments of FIG. 10, the optimal weight threshold is determined before the optimal activation threshold is determined. In other embodiments, the optimal weight threshold may be determined after the optimal activation threshold is determined.

Example PE Array

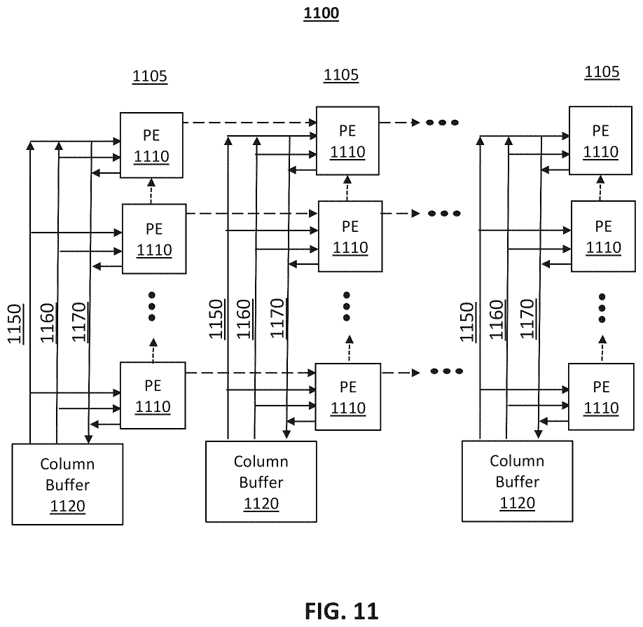

FIG. 11 illustrates an example PE array, in accordance with various embodiments. The PE array 1100 may be an embodiment of the PE array 350 in FIG. 3. The PE array 1100 includes a plurality of PEs 1110 (individually referred to as “PE 1110”). The PEs 1110 can perform MAC operations, including MAC operations in quantized inference. The PEs 1110 may also be referred to as neurons in the DNN. Each PE 1110 has two input signals 1150 and 1160 and an output signal 1170. The input signal 1150 is at least a portion of an IFM to the layer. The input signal 1160 is at least a portion of a filter of the layer. In some embodiments, the input signal 1150 of a PE 1110 includes one or more input operands, and the input signal 1160 includes one or more weight operands.

Each PE 1110 performs an MAC operation on the input signals 1150 and 1160 and outputs the output signal 1170, which is a result of the MAC operation. Some or all of the input signals 1150 and 1160 and the output signal 1170 may be in an integer format, such as INT8, or floating-point format, such as FP16 or BF16. For the purpose of simplicity and illustration, the input signals and output signal of all the PEs 1110 have the same reference numbers, but the PEs 1110 may receive different input signals and output different output signals from each other. Also, a PE 1110 may be different from another PE 1110, e.g., including more, fewer, or different components.

As shown in FIG. 11, the PEs 1110 are connected to each other, as indicated by the dash arrows in FIG. 11. The output signal 1170 of an PE 1110 may be sent to many other PEs 1110 (and possibly back to itself) as input signals via the interconnections between PEs 1110. In some embodiments, the output signal 1170 of an PE 1110 may incorporate the output signals of one or more other PEs 1110 through an accumulate operation of the PE 1110 and generates an internal partial sum of the PE array.

In the embodiments of FIG. 11, the PEs 1110 are arranged into columns 1105 (individually referred to as “column 1105”). The input and weights of the layer may be distributed to the PEs 1110 based on the columns 1105. Each column 1105 has a column buffer 1120. The column buffer 1120 stores data provided to the PEs 1110 in the column 1105 for a short amount of time. The column buffer 1120 may also store data output by the last PE 1110 in the column 1105. The output of the last PE 1110 may be a sum of the MAC operations of all the PEs 1110 in the column 1105, which is a column-level internal partial sum of the PE array 1100. In other embodiments, input and weights may be distributed to the PEs 1110 based on rows in the PE array 1100. The PE array 1100 may include row buffers in lieu of column buffers 1120. A row buffer may store input signals of the PEs in the corresponding row and may also store a row-level internal partial sum of the PE array 1100.

In some embodiments, a column buffer 1120 may be a portion of the local memory 340 in FIG. 3. The column buffer 1120 may be associated with upper memory hierarchies, e.g., the memory 310 in FIG. 3. Data in the column buffer 1120 may be sent to the upper memory hierarchies. The column buffer 1120 may receive data from the upper memory hierarchies.

FIG. 12 is a block diagram of a PE 1200, in accordance with various embodiments. The PE 1200 may be an embodiment of the PE 1110 in FIG. 11 or an embodiment of a PE in the PE array 350 in FIG. 3. The PE 1200 may perform MAC operations, e.g., MAC operations using data in integer formats. As shown in FIG. 12, the PE 1200 includes input register files 1210 (individually referred to as “input register file 1210”), weight registers file 1220 (individually referred to as “weight register file 1220”), multipliers 1230 (individually referred to as “multiplier 1230”), an internal adder assembly 1240, and an output register file 1250. In other embodiments, the PE 1200 may include fewer, more, or different components. For example, the PE 1200 may include multiple output register files 1250. As another example, the PE 1200 may include a single input register file 1210, weight register file 1220, or multiplier 1230. As yet another example, the PE 1200 may include an adder in lieu of the internal adder assembly 1240.

The input register files 1210 temporarily store input operands for MAC operations by the PE 1200. In some embodiments, an input register file 1210 may store a single input operand at a time. In other embodiments, an input register file 1210 may store multiple input operand or a portion of an input operand at a time. An input operand includes a plurality of input elements (i.e., input elements) in an input tensor. The input elements of an input operand may be stored sequentially in the input register file 1210 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X, Y) coordinates, which may be used as the (X, Y) coordinates of the input operand. For instance, all the input elements of an input operand may be X0Y0, X0Y1, X1Y1, etc.

The weight register file 1220 temporarily stores weight operands for MAC operations by the PE 1200. The weight operands include weights in the filters of the DNN layer. In some embodiments, the weight register file 1220 may store a single weight operand at a time. other embodiments, an input register file 1210 may store multiple weight operands or a portion of a weight operand at a time. A weight operand may include a plurality of weights. The weights of a weight operand may be stored sequentially in the weight register file 1220 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1220 may be the same or similar as an input register file 1210, e.g., having the same size, etc. The PE 1200 may include a plurality of register files, some of which are designated as the input register files 1210 for storing input operands, some of which are designated as the weight register files 1220 for storing weight operands, and some of which are designated as the output register file 1250 for storing output operands. In other embodiments, register files in the PE 1200 may be designated for other purposes, e.g., for storing scale operands used in elementwise add operations, etc.

The multipliers 1230 perform multiplication operations on input operands and weight operands. A multiplier 1230 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1230 may perform multiplication operations simultaneously. These multiplication operations may be referred to as a round of multiplication operations. In a round of multiplication operations by the multipliers 1230, each of the multipliers 1230 may use a different input operand and a different weight operand. The different input operands or weight operands may be stored in different register files of the PE 1200. For instance, a first multiplier 1230 uses a first input operand (e.g., stored in a first input register file 1210) and a first weight operand (e.g., stored in a first weight register file 1220), versus a second multiplier 1230 uses a second input operand (e.g., stored in a second input register file 1210) and a second weight operand (e.g., stored in a second weight register file 1220), a third multiplier 1230 uses a third input operand (e.g., stored in a third input register file 1210) and a third weight operand (e.g., stored in a third weight register file 1220), and so on. For an individual multiplier 1230, the round of multiplication operations may include a plurality of cycles. A cycle includes a multiplication operation on an input element and a weight.

The multipliers 1230 may perform multiple rounds of multiplication operations. A multiplier 1230 may use the same weight operand but different input operands in different rounds. For instance, the multiplier 1230 performs a sequence of multiplication operations on a first input operand stored in a first input register file in a first round, versus a second input operand stored in a second input register file in a second round. In the second round, a different multiplier 1230 may use the first input operand and a different weight operand to perform another sequence of multiplication operations. That way, the first input operand is reused in the second round. The first input operand may be further reused in additional rounds, e.g., by additional multipliers 1230.

The internal adder assembly 1240 includes one or more adders inside the PE 1200, i.e., internal adders. The internal adder assembly 1240 may perform accumulation operations on two or more products operands from multipliers 1230 and produce an output operand of the PE 1200. In some embodiments, the internal adders are arranged in a sequence of tiers. A tier includes one or more internal adders. For the first tier of the internal adder assembly 1240, an internal adder may receive product operands from two or more multipliers 1230 and generate a sum operand through a sequence of accumulation operations. Each accumulation operation produces a sum of two or more products, each of which is from a different multiplier 1230. The sum operand includes a sequence of sums, each of which is a result of an accumulation operation and corresponds to a depthwise channel. For the other tier(s) of the internal adder assembly 1240, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1240 may include a single internal adder, which produces the output operand of the PE 1200.

The output register file 1250 stores output operands of the PE 1200. In some embodiments, the output register file 1250 may store an output operand at a time. In other embodiments, the output register file 1250 may store multiple output operands or a portion of an output operand at a time. An output operand includes a plurality of output elements in an IFM. The output elements of an output operand may be stored sequentially in the output register file 1250 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

Example Method of Modifying DNNs

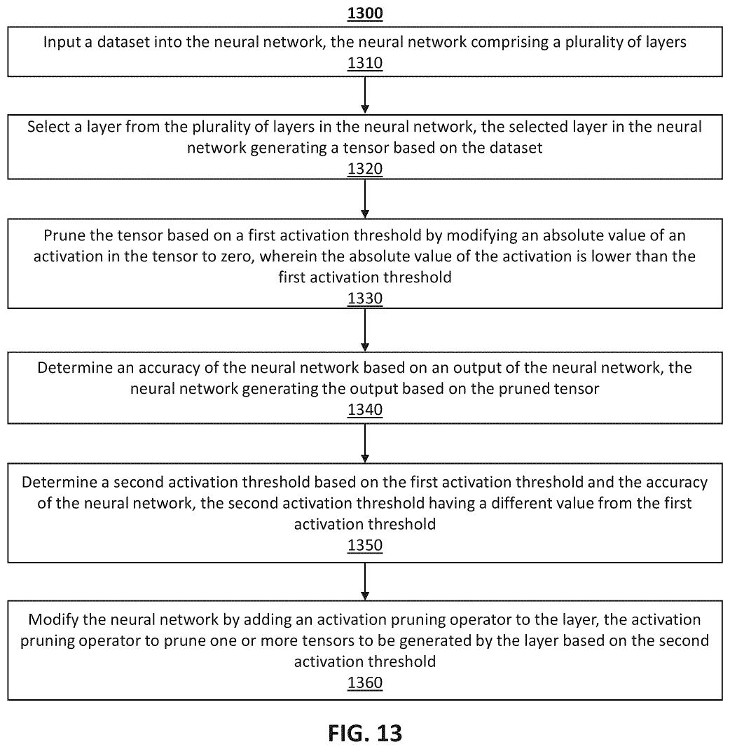

FIG. 13 is a flowchart showing a method 1300 of modifying a DNN, in accordance with various embodiments. The method 1300 may be performed by the compressing module 700 in FIG. 7. Although the method 1300 is described with reference to the flowchart illustrated in FIG. 13, many other methods for modifying DNNs may alternatively be used. For example, the order of execution of the steps in FIG. 13 may be changed. As another example, some of the steps may be changed, eliminated, or combined.

The compressing module 700 inputs 1310 a dataset into the neural network. The neural network comprises a plurality of layers. The compressing module 700 selects 1320 a layer from the plurality of layers. The selected layer in the neural network generates a tensor based on the dataset. In some embodiments, the compressing module 700 selects the layer based on an amount of internal parameters of the layer (e.g., the number of weights, etc.), an amount of computations in the layer (e.g., the number of MAC operations, etc.), a type of the layer, or some combination thereof.

The compressing module 700 prunes 1330 the tensor based on a first activation threshold by modifying an absolute value of an activation in the tensor to zero. The absolute value of the activation is lower than the first activation threshold.

The compressing module 700 determines 1340 an accuracy of the neural network based on an output of the neural network. The neural network generates the output based on the pruned tensor.

The compressing module 700 determines 1350 a second activation threshold based on the first activation threshold and the accuracy of the neural network. The second activation threshold has a different value from the first activation threshold. In some embodiments, the compressing module 700 determines an accuracy loss caused by pruning the tensor based on the accuracy of the neural network. The compressing module 700 determines whether the accuracy loss exceeds a threshold. In response to determining that the accuracy loss is lower than the threshold, the compressing module 700 determines the second activation threshold by increasing the first activation threshold. In response to determining that the accuracy loss exceeds the threshold, the compressing module 700 determines the second activation threshold by decreasing the first activation threshold.

In some embodiments, the compressing module 700 determines the first activation threshold based on a third activation threshold. The third activation threshold is different from the first activation threshold and the second activation threshold. The third activation threshold may be lower than the first activation threshold. In some embodiments, the compressing module 700 inputs an additional dataset into the neural network. The layer in the neural network generates an additional tensor based on the additional dataset. The compressing module 700 prunes the additional tensor based on the third activation threshold. The compressing module 700 determines an additional accuracy of the neural network based on an additional output generated by the neural network based on the pruned additional tensor. The compressing module 700 determines the first activation threshold based on the third activation threshold and the additional accuracy of the neural network.

The compressing module 700 modifies 1360 the neural network by adding an activation pruning operation to the layer. The activation pruning operation is to prune one or more tensors to be generated by the layer based on the second activation threshold. In some embodiments, the compressing module 700 further modifies the neural network by adding a weight pruning operation to the layer. The activation pruning operation is to prune a kernel the layer based on a weight threshold by modifying a value of a weight in the kernel to zero. The value of the weight is lower than the weight threshold. In some embodiments, the neural network has been trained to determine the value of the weight. In some embodiments, the compressing module 700 determines the second activation threshold after adding the weight pruning operation to the layer.

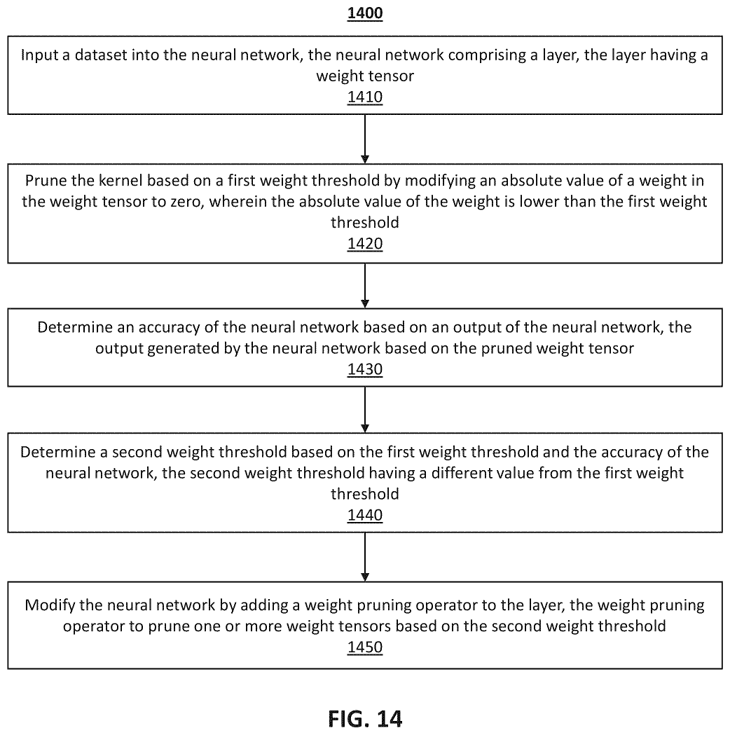

FIG. 14 is a flowchart showing another method 1400 of modifying a DNN, in accordance with various embodiments. The method 1400 may be performed by the compressing module 700 in FIG. 7. Although the method 1400 is described with reference to the flowchart illustrated in FIG. 14, many other methods for modifying DNNs may alternatively be used. For example, the order of execution of the steps in FIG. 14 may be changed. As another example, some of the steps may be changed, eliminated, or combined.

The compressing module 700 inputs 1410 a dataset into the neural network. The neural network comprises a layer. The layer has a weight tensor. The weight tensor may be a filter, kernel, a vector in a filter, and so on. In some embodiments, the compressing module 700 selects the layer from a plurality of layers in the neural network based on a number of internal parameters of the layer, a number of operations in the layer, a type of the layer, or some combination thereof.

The compressing module 700 prunes 1420 the weight tensor based on a first weight threshold by modifying an absolute value of a weight in the weight tensor to zero. The absolute value of the weight is lower than the first weight threshold. In some embodiments, the compressing module 700 determines the first weight threshold based on absolute values of a plurality of weights in the weight tensor, a first threshold (e.g., a maximum constraint), and a second threshold (e.g., a minimum constraint). The first weight threshold is lower than the first threshold and is greater than the second threshold. In some embodiments, the compressing module 700 determines that a minimum absolute value of a plurality of weights in the weight tensor is lower than the second threshold.

In some embodiments, the compressing module 700 determines one or more quantiles based on the absolute values of the plurality of weights. The compressing module 700 selects a quantile from the one or more quantiles based on the first threshold. The compressing module 700 selects a greater one of the selected quantile and the second threshold as the first weight threshold. In some embodiments, the selected quantile has a value that is greater than a value of another quantile of the one or more quantiles and is lower than the first threshold.

In some embodiments, the compressing module 700 determines the first weight threshold. The compressing module 700 inputs an additional dataset into the neural network. The compressing module 700 prunes the weight tensor based on a third weight threshold that is lower than the first weight threshold. The compressing module 700 determines an additional accuracy of the neural network based on an additional output generated by the neural network using the weight tensor pruned based on the third weight threshold. The compressing module 700 determines the first weight threshold based on the additional accuracy of the neural network.

The compressing module 700 determines 1430 an accuracy of the neural network based on an output of the neural network. The output is generated by the neural network based on the pruned weight tensor.

The compressing module 700 determines 1440 a second weight threshold based on the first weight threshold and the accuracy of the neural network. The second weight threshold has a different value from the first weight threshold. In some embodiments, the compressing module 700 determines an accuracy loss caused by pruning the weight tensor based on the accuracy of the neural network. The compressing module 700 determines whether the accuracy loss is less than a threshold. In response to determining that the accuracy loss is less than the threshold, the compressing module 700 determines the second weight threshold by increasing the second threshold. In response to determining that the accuracy loss is greater than or equal to the threshold, the compressing module 700 determines the second weight threshold based on a predetermined weight threshold. The predetermined weight threshold is lower than the first weight threshold.

The compressing module 700 modifies 1450 the neural network by adding a weight pruning operation to the layer. The weight pruning operation is to prune the weight tensor based on the second weight threshold. In some embodiments, the compressing module 700 further modifies the neural network by adding an activation pruning operation to the layer, the activation pruning operation to prune a tensor generated by the layer using the weight tensor after the weight tensor is pruned by the weight pruning operation.

Example Computing Device

FIG. 15 is a block diagram of an example computing device 1500, in accordance with various embodiments. In some embodiments, the computing device 1500 can be used as at least part of the DNN system 300. A number of components are illustrated in FIG. 15 as included in the computing device 1500, but any one or more of these components may be omitted or duplicated, as suitable for the application. In some embodiments, some or all of the components included in the computing device 1500 may be attached to one or more motherboards. In some embodiments, some or all of these components are fabricated onto a single system on a chip (SoC) die. Additionally, in various embodiments, the computing device 1500 may not include one or more of the components illustrated in FIG. 15, but the computing device 1500 may include interface circuitry for coupling to the one or more components. For example, the computing device 1500 may not include a display device 1506, but may include display device interface circuitry (e.g., a connector and driver circuitry) to which a display device 1506 may be coupled. In another set of examples, the computing device 1500 may not include an audio input device 1518 or an audio output device 1508, but may include audio input or output device interface circuitry (e.g., connectors and supporting circuitry) to which an audio input device 1518 or audio output device 1508 may be coupled.

The computing device 1500 may include a processing device 1502 (e.g., one or more processing devices). The processing device 1502 processes electronic data from registers and/or memory to transform that electronic data into other electronic data that may be stored in registers and/or memory. The computing device 1500 may include a memory 1504, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1504 may include memory that shares a die with the processing device 1502. In some embodiments, the memory 1504 includes one or more non-transitory computer-readable media storing instructions executable to perform operations for pruning weights in DNNs, e.g., the method 1300 described above in conjunction with FIG. 13, the method 1400 described above in conjunction with FIG. 14, or some operations performed by the DNN module 600 (e.g., the compressing module 630, etc.) described above in conjunction with FIG. 6. The instructions stored in the one or more non-transitory computer-readable media may be executed by the processing device 1502.

In some embodiments, the computing device 1500 may include a communication chip 1512 (e.g., one or more communication chips). For example, the communication chip 1512 may be configured for managing wireless communications for the transfer of data to and from the computing device 1500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1512 may operate in accordance with other wireless protocols in other embodiments. The computing device 1500 may include an antenna 1522 to facilitate wireless communications and/or to receive other wireless communications (such as AM or FM radio transmissions).

In some embodiments, the communication chip 1512 may manage wired communications, such as electrical, optical, or any other suitable communication protocols (e.g., the Ethernet). As noted above, the communication chip 1512 may include multiple communication chips. For instance, a first communication chip 1512 may be dedicated to shorter-range wireless communications such as Wi-Fi or Bluetooth, and a second communication chip 1512 may be dedicated to longer-range wireless communications such as global positioning system (GPS), EDGE, GPRS, CDMA, WiMAX, LTE, EV-DO, or others. In some embodiments, a first communication chip 1512 may be dedicated to wireless communications, and a second communication chip 1512 may be dedicated to wired communications.

The computing device 1500 may include battery/power circuitry 1514. The battery/power circuitry 1514 may include one or more energy storage devices (e.g., batteries or capacitors) and/or circuitry for coupling components of the computing device 1500 to an energy source separate from the computing device 1500 (e.g., AC line power).

The computing device 1500 may include a display device 1506 (or corresponding interface circuitry, as discussed above). The display device 1506 may include any visual indicators, such as a heads-up display, a computer monitor, a projector, a touchscreen display, a liquid crystal display (LCD), a light-emitting diode display, or a flat panel display, for example.

The computing device 1500 may include an audio output device 1508 (or corresponding interface circuitry, as discussed above). The audio output device 1508 may include any device that generates an audible indicator, such as speakers, headsets, or earbuds, for example.

The computing device 1500 may include an audio input device 1518 (or corresponding interface circuitry, as discussed above). The audio input device 1518 may include any device that generates a signal representative of a sound, such as microphones, microphone arrays, or digital instruments (e.g., instruments having a musical instrument digital interface (MIDI) output).

The computing device 1500 may include a GPS device 1516 (or corresponding interface circuitry, as discussed above). The GPS device 1516 may be in communication with a satellite-based system and may receive a location of the computing device 1500, as known in the art.

The computing device 1500 may include another output device 1510 (or corresponding interface circuitry, as discussed above). Examples of the other output device 1510 may include an audio codec, a video codec, a printer, a wired or wireless transmitter for providing information to other devices, or an additional storage device.

The computing device 1500 may include another input device 1520 (or corresponding interface circuitry, as discussed above). Examples of the other input device 1520 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1500 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1500 may be any other electronic device that processes data.

Select Examples

The following paragraphs provide various examples of the embodiments disclosed herein.

Example 1 provides a method for modifying a neural network, including inputting a dataset into the neural network, the neural network including a plurality of layers; selecting a layer from the plurality of layers in the neural network, the selected layer in the neural network generating a tensor based on the dataset; pruning the tensor based on a first activation threshold by modifying an absolute value of an activation in the tensor to zero, in which the absolute value of the activation is lower than the first activation threshold; determining an accuracy of the neural network based on an output of the neural network, the neural network generating the output based on the pruned tensor; determining a second activation threshold based on the first activation threshold and the accuracy of the neural network, the second activation threshold having a different value from the first activation threshold; and modifying the neural network by adding an activation pruning operation to the layer, the activation pruning operation to prune one or more tensors to be generated by the layer based on the second activation threshold.

Example 2 provides the method of example 1, in which determining the second activation threshold includes determining an accuracy loss caused by pruning the tensor based on the accuracy of the neural network; determine whether the accuracy loss exceeds a threshold; and in response to determining that the accuracy loss is lower than the threshold, determining the second activation threshold by increasing the first activation threshold.

Example 3 provides the method of example 2, in which determining the second activation threshold further includes in response to determining that the accuracy loss exceeds the threshold, determining the second activation threshold by decreasing the first activation threshold.

Example 4 provides the method of any one of examples 1-3, further including determining the first activation threshold based on a third activation threshold, in which the third activation threshold is different from the first activation threshold and the second activation threshold.

Example 5 provides the method of example 4, in which determining the first activation threshold includes inputting an additional dataset into the neural network, the selected layer in the neural network generating an additional tensor based on the additional dataset; pruning the additional tensor based on the third activation threshold; determining an additional accuracy of the neural network based on an additional output generated by the neural network based on the pruned additional tensor; and determining the first activation threshold based on the third activation threshold and the additional accuracy of the neural network.

Example 6 provides the method of any one of examples 1-5, further including selecting another layer in the neural network; and modifying the neural network by adding another activation pruning operation to the another layer, the another activation pruning operation to prune one or more tensors to be generated by the another layer based on another activation threshold.

Example 7 provides the method of any one of examples 1-6, in which selecting the layer includes selecting the layer based on an amount of internal parameters of the layer, an amount of computations in the layer, a type of the layer, or some combination thereof.

Example 8 provides the method of any one of examples 1-7, further including further modifying the neural network by adding a weight pruning operation to the selected layer, the activation pruning operation to prune a kernel of the selected the layer based on a weight threshold by modifying an absolute value of a weight in the kernel to zero, in which the absolute value of the weight is lower than the weight threshold.

Example 9 provides the method of example 8, in which the neural network has been trained to determine the absolute value of the weight.

Example 10 provides the method of example 8 or 9, in which determining the second activation threshold includes determining the second activation threshold after adding the weight pruning operation to the layer.

Example 11 provides one or more non-transitory computer-readable media storing instructions executable to perform operations for modifying a neural network, the operations including inputting a dataset into the neural network, the neural network including a plurality of layers; selecting a layer from the plurality of layers in the neural network, the selected layer in the neural network generating a tensor based on the dataset; pruning the tensor based on a first activation threshold by modifying an absolute value of an activation in the tensor to zero, in which the absolute value of the activation is lower than the first activation threshold; determining an accuracy of the neural network based on an output of the neural network, the neural network generating the output based on the pruned tensor; determining a second activation threshold based on the first activation threshold and the accuracy of the neural network, the second activation threshold having a different value from the first activation threshold; and modifying the neural network by adding an activation pruning operation to the layer, the activation pruning operation to prune one or more tensors to be generated by the layer based on the second activation threshold.

Example 12 provides the one or more non-transitory computer-readable media of example 11, in which determining the second activation threshold includes determining an accuracy loss caused by pruning the tensor based on the accuracy of the neural network; determine whether the accuracy loss exceeds a threshold; and in response to determining that the accuracy loss is lower than the threshold, determining the second activation threshold by increasing the first activation threshold.

Example 13 provides the one or more non-transitory computer-readable media of example 12, in which determining the second activation threshold further includes in response to determining that the accuracy loss exceeds the threshold, determining the second activation threshold by decreasing the first activation threshold.

Example 14 provides the one or more non-transitory computer-readable media of any one of examples 11-13, in which the operations further include determining the first activation threshold based on a third activation threshold, in which the third activation threshold is different from the first activation threshold and the second activation threshold.

Example 15 provides the one or more non-transitory computer-readable media of example 14, in which determining the first activation threshold includes inputting an additional dataset into the neural network, the selected layer in the neural network generating an additional tensor based on the additional dataset; pruning the additional tensor based on the third activation threshold; determining an additional accuracy of the neural network based on an additional output generated by the neural network based on the pruned additional tensor; and determining the first activation threshold based on the third activation threshold and the additional accuracy of the neural network.

Example 16 provides the one or more non-transitory computer-readable media of any one of examples 11-15, in which the operations further include selecting another layer in the neural network; and modifying the neural network by adding another activation pruning operation to the another layer, the another activation pruning operation to prune one or more tensors to be generated by the another layer based on another activation threshold.

Example 17 provides the one or more non-transitory computer-readable media of any one of examples 11-16, in which selecting the layer includes selecting the layer based on an amount of internal parameters of the layer, an amount of computations in the layer, a type of the layer, or some combination thereof.

Example 18 provides the one or more non-transitory computer-readable media of any one of examples 11-17, in which the operations further include further modifying the neural network by adding a weight pruning operation to the selected layer, the activation pruning operation to prune a kernel of the selected the layer based on a weight threshold by modifying an absolute value of a weight in the kernel to zero, in which the absolute value of the weight is lower than the weight threshold.

Example 19 provides the one or more non-transitory computer-readable media of example 18, in which the neural network has been trained to determine the absolute value of the weight.

Example 20 provides the one or more non-transitory computer-readable media of example 18 or 19, in which determining the second activation threshold includes determining the second activation threshold after adding the weight pruning operation to the layer.

Example 21 provides an apparatus, including a computer processor for executing computer program instructions; and a non-transitory computer-readable memory storing computer program instructions executable by the computer processor to perform operations for modifying a neural network, the operations including inputting a dataset into the neural network, the neural network including a plurality of layers, selecting a layer from the plurality of layers in the neural network, the selected layer in the neural network generating a tensor based on the dataset, pruning the tensor based on a first activation threshold by modifying an absolute value of an activation in the tensor to zero, in which the absolute value of the activation is lower than the first activation threshold, determining an accuracy of the neural network based on an output of the neural network, the neural network generating the output based on the pruned tensor, determining a second activation threshold based on the first activation threshold and the accuracy of the neural network, the second activation threshold having a different value from the first activation threshold, and modifying the neural network by adding an activation pruning operation to the layer, the activation pruning operation to prune one or more tensors to be generated by the layer based on the second activation threshold.

Example 22 provides the apparatus of example 21, in which determining the second activation threshold includes determining an accuracy loss caused by pruning the tensor based on the accuracy of the neural network; determine whether the accuracy loss exceeds a threshold; in response to determining that the accuracy loss is lower than the threshold, determining the second activation threshold by increasing the first activation threshold; and in response to determining that the accuracy loss exceeds the threshold, determining the second activation threshold by decreasing the first activation threshold.

Example 23 provides the apparatus of example 21 or 22, in which the operations further include determining the first activation threshold based on a third activation threshold by: inputting an additional dataset into the neural network, the layer in the neural network generating an additional tensor based on the additional dataset; pruning the additional tensor based on a third activation threshold, in which the third activation threshold is different from the first activation threshold and the second activation threshold; determining an additional accuracy of the neural network based on an additional output generated by the neural network based on the pruned additional tensor; and determining the first activation threshold based on the third activation threshold and the additional accuracy of the neural network.

Example 24 provides the apparatus of any one of examples 21-23, in which the operations further include further modifying the neural network by adding a weight pruning operation to the layer, the activation pruning operation to prune a kernel the layer based on a weight threshold by modifying an absolute value of a weight in the kernel to zero, in which the absolute value of the weight is lower than the weight threshold.

Example 25 provides the apparatus of any one of examples 21-24, in which the operations further include selecting another layer in the neural network; and modifying the neural network by adding another activation pruning operation to the another layer, the another activation pruning operation to prune one or more tensors to be generated by the another layer based on another activation threshold.

Additional Select Examples

The following paragraphs provide various examples of the embodiments disclosed herein.

Example 1 provides a method of modifying a neural network, including: inputting a dataset into the neural network, the neural network including a layer, the layer having a weight tensor; pruning the weight tensor based on a first weight threshold by modifying an absolute value of a weight in the weight tensor to zero, where the absolute value of the weight is lower than the first weight threshold; determining an accuracy of the neural network based on an output of the neural network, the output generated by the neural network based on the pruned weight tensor; determining a second weight threshold based on the first weight threshold and the accuracy of the neural network, the second weight threshold having a different value from the first weight threshold; and modifying the neural network by adding a weight pruning operation to the layer, the weight pruning operation to prune one or more weight tensors based on the second weight threshold.

Example 2 provides the method of example 1, further including: determining the first weight threshold based on absolute values of a plurality of weights in the weight tensor, a first threshold, and a second threshold, where the first weight threshold is lower than the first threshold and is greater than the second threshold.

Example 3 provides the method of example 2, where determining the first weight threshold includes: determining one or more quantiles based on the absolute values of the plurality of weights; selecting a quantile from the one or more quantiles based on the first threshold; and selecting a greater one of the selected quantile and the second threshold as the first weight threshold.

Example 4 provides the method of example 3, where the selected quantile has a value that is greater than a value of another quantile of the one or more quantiles and is lower than the first threshold.

Example 5 provides the method of any one of examples 2-4, where determining the second weight threshold includes: determining an accuracy loss caused by pruning the weight tensor based on the accuracy of the neural network; determine whether the accuracy loss is less than a threshold; and in response to determining that the accuracy loss is less than the threshold, determining the second weight threshold by increasing the second threshold.

Example 6 provides the method of example 5, where determining the second weight threshold further includes: in response to determining that the accuracy loss is greater than or equal to the threshold, determining the second weight threshold based on a predetermined weight threshold, where the predetermined weight threshold is lower than the first weight threshold.

Example 7 provides the method of any one of examples 2-6, further including: determining that a minimum absolute value of a plurality of weights in the weight tensor is lower than the second threshold.

Example 8 provides the method of any one of examples 1-7, further including determining the first weight threshold by: inputting an additional dataset into the neural network; pruning the weight tensor based on a third weight threshold that is lower than the first weight threshold; determining an additional accuracy of the neural network based on an additional output generated by the neural network using the weight tensor pruned based on the third weight threshold; and determining the first activation threshold based on the additional accuracy of the neural network.

Example 9 provides the method of any one of examples 1-8, further including: selecting the layer from a plurality of layers in the neural network based on a number of internal parameters of the layer, a number of operations in the layer, a type of the layer, or some combination thereof.

Example 10 provides the method of any one of examples 1-9, further including: further modifying the neural network by adding an activation pruning operation to the layer, the activation pruning operation to prune a tensor generated by the layer using the weight tensor after the weight tensor is pruned by the weight pruning operation.

Example 11 provides one or more non-transitory computer-readable media storing instructions executable to perform operations for modifying a neural network, the operations including: inputting a dataset into the neural network, the neural network including a layer, the layer having a weight tensor; pruning the weight tensor based on a first weight threshold by modifying an absolute value of a weight in the weight tensor to zero, where the absolute value of the weight is lower than the first weight threshold; determining an accuracy of the neural network based on an output of the neural network, the output generated by the neural network based on the pruned weight tensor; determining a second weight threshold based on the first weight threshold and the accuracy of the neural network, the second weight threshold having a different value from the first weight threshold; and modifying the neural network by adding a weight pruning operation to the layer, the weight pruning operation to prune one or more weight tensors based on the second weight threshold.

Example 12 provides the one or more non-transitory computer-readable media of example 11, where the operations further include: determining the first weight threshold based on absolute values of a plurality of weights in the weight tensor, a first threshold, and a second threshold, where the first weight threshold is lower than the first threshold and is greater than the second threshold.

Example 13 provides the one or more non-transitory computer-readable media of example 12, where determining the first weight threshold includes: determining one or more quantiles based on the absolute values of the plurality of weights; selecting a quantile from the one or more quantiles based on the first threshold; and selecting a greater one of the selected quantile and the second threshold as the first weight threshold.

Example 14 provides the one or more non-transitory computer-readable media of example 12 or 13, where determining the second weight threshold includes: determining an accuracy loss caused by pruning the weight tensor based on the accuracy of the neural network; determine whether the accuracy loss is less than a threshold; in response to determining that the accuracy loss is less than the threshold, determining the second weight threshold by increasing the second threshold; and in response to determining that the accuracy loss is greater than or equal to the threshold, determining the second weight threshold based on a predetermined weight threshold, where the predetermined weight threshold is lower than the first weight threshold.

Example 15 provides the one or more non-transitory computer-readable media of any one of examples 11-14, where the operations further include determining the first weight threshold by: inputting an additional dataset into the neural network; pruning the weight tensor based on a third weight threshold that is lower than the first weight threshold; determining an additional accuracy of the neural network based on an additional output generated by the neural network using the weight tensor pruned based on the third weight threshold; and determining the first activation threshold based on the additional accuracy of the neural network.

Example 16 provides the one or more non-transitory computer-readable media of any one of examples 11-15, where the operations further include: further modifying the neural network by adding an activation pruning operation to the layer, the activation pruning operation to prune a tensor generated by the layer using the weight tensor after the weight tensor is pruned by the weight pruning operation.

Example 17 provides an apparatus, including a computer processor for executing computer program instructions; and a non-transitory computer-readable memory storing computer program instructions executable by the computer processor to perform operations for modifying a neural network, the operations including: inputting a dataset into the neural network, the neural network including a layer, the layer having a weight tensor, pruning the weight tensor based on a first weight threshold by modifying an absolute value of a weight in the weight tensor to zero, where the absolute value of the weight is lower than the first weight threshold, determining an accuracy of the neural network based on an output of the neural network, the output generated by the neural network based on the pruned weight tensor, determining a second weight threshold based on the first weight threshold and the accuracy of the neural network, the second weight threshold having a different value from the first weight threshold, and modifying the neural network by adding a weight pruning operation to the layer, the weight pruning operation to prune one or more weight tensors based on the second weight threshold.

Example 18 provides the apparatus of example 17, where the operations further include determining the first weight threshold based on absolute values of a plurality of weights in the weight tensor, a first threshold, and a second threshold, where the first weight threshold is lower than the first threshold and is greater than the second threshold.

Example 19 provides the apparatus of example 18, where determining the first weight threshold includes: determining one or more quantiles based on the absolute values of the plurality of weights; selecting a quantile from the one or more quantiles based on the first threshold; and selecting a greater one of the selected quantile and the second threshold as the first weight threshold.

Example 20 provides the apparatus of example 18 or 19, where determining the second weight threshold includes: determining an accuracy loss caused by pruning the weight tensor based on the accuracy of the neural network; determine whether the accuracy loss is less than a threshold; in response to determining that the accuracy loss is less than the threshold, determining the second weight threshold by increasing the second threshold; and in response to determining that the accuracy loss is greater than or equal to the threshold, determining the second weight threshold based on a predetermined weight threshold, where the predetermined weight threshold is lower than the first weight threshold.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for modifying a neural network, comprising:
inputting a dataset into the neural network, the neural network comprising a plurality of layers;
selecting a layer from the plurality of layers in the neural network, the selected layer in the neural network generating a tensor based on the dataset;
pruning the tensor based on a first activation threshold by modifying an absolute value of an activation in the tensor to zero, wherein the absolute value of the activation is lower than the first activation threshold;
determining an accuracy of the neural network based on an output of the neural network, the neural network generating the output based on the pruned tensor;
determining a second activation threshold based on the first activation threshold and the accuracy of the neural network, the second activation threshold having a different value from the first activation threshold; and
modifying the neural network by adding an activation pruning operation to the layer, the activation pruning operation to prune one or more tensors to be generated by the layer based on the second activation threshold.

2. The method of claim 1, wherein determining the second activation threshold comprises:
determining an accuracy loss caused by pruning the tensor based on the accuracy of the neural network;
determine whether the accuracy loss exceeds a threshold; and
in response to determining that the accuracy loss is lower than the threshold, determining the second activation threshold by increasing the first activation threshold.

3. The method of claim 2, wherein determining the second activation threshold further comprises:
in response to determining that the accuracy loss exceeds the threshold, determining the second activation threshold by decreasing the first activation threshold.

4. The method of claim 1, further comprising:
determining the first activation threshold based on a third activation threshold,
wherein the third activation threshold is different from the first activation threshold and the second activation threshold.

5. The method of claim 4, wherein determining the first activation threshold comprises:
inputting an additional dataset into the neural network, the selected layer in the neural network generating an additional tensor based on the additional dataset;
pruning the additional tensor based on the third activation threshold;
determining an additional accuracy of the neural network based on an additional output generated by the neural network based on the pruned additional tensor; and
determining the first activation threshold based on the third activation threshold and the additional accuracy of the neural network.

6. The method of claim 1, further comprising:
selecting another layer in the neural network; and
modifying the neural network by adding another activation pruning operation to the another layer, the another activation pruning operation to prune one or more tensors to be generated by the another layer based on another activation threshold.

7. The method of claim 1, wherein selecting the layer comprises:
selecting the layer based on an amount of internal parameters of the layer, an amount of computations in the layer, a type of the layer, or some combination thereof.

8. The method of claim 1, further comprising:
further modifying the neural network by adding a weight pruning operation to the selected layer, the activation pruning operation to prune a kernel of the selected the layer based on a weight threshold by modifying an absolute value of a weight in the kernel to zero,
wherein the absolute value of the weight is lower than the weight threshold.

9. The method of claim 8, wherein the neural network has been trained to determine the absolute value of the weight.

10. The method of claim 8, wherein determining the second activation threshold comprises:
determining the second activation threshold after adding the weight pruning operation to the layer.

11. One or more non-transitory computer-readable media storing instructions executable to perform operations for modifying a neural network, the operations comprising:
inputting a dataset into the neural network, the neural network comprising a plurality of layers;
selecting a layer from the plurality of layers in the neural network, the selected layer in the neural network generating a tensor based on the dataset;
pruning the tensor based on a first activation threshold by modifying an absolute value of an activation in the tensor to zero, wherein the absolute value of the activation is lower than the first activation threshold;
determining an accuracy of the neural network based on an output of the neural network, the neural network generating the output based on the pruned tensor;
determining a second activation threshold based on the first activation threshold and the accuracy of the neural network, the second activation threshold having a different value from the first activation threshold; and
modifying the neural network by adding an activation pruning operation to the layer, the activation pruning operation to prune one or more tensors to be generated by the layer based on the second activation threshold.

12. The one or more non-transitory computer-readable media of claim 11, wherein determining the second activation threshold comprises:
determining an accuracy loss caused by pruning the tensor based on the accuracy of the neural network;
determine whether the accuracy loss exceeds a threshold; and
in response to determining that the accuracy loss is lower than the threshold, determining the second activation threshold by increasing the first activation threshold.

13. The one or more non-transitory computer-readable media of claim 12, wherein determining the second activation threshold further comprises:
in response to determining that the accuracy loss exceeds the threshold, determining the second activation threshold by decreasing the first activation threshold.

14. The one or more non-transitory computer-readable media of claim 11, wherein the operations further comprise:
determining the first activation threshold based on a third activation threshold,
wherein the third activation threshold is different from the first activation threshold and the second activation threshold.

15. The one or more non-transitory computer-readable media of claim 14, wherein determining the first activation threshold comprises:
inputting an additional dataset into the neural network, the selected layer in the neural network generating an additional tensor based on the additional dataset;
pruning the additional tensor based on the third activation threshold;
determining an additional accuracy of the neural network based on an additional output generated by the neural network based on the pruned additional tensor; and
determining the first activation threshold based on the third activation threshold and the additional accuracy of the neural network.

16. The one or more non-transitory computer-readable media of claim 11, wherein the operations further comprise:
selecting another layer in the neural network; and
modifying the neural network by adding another activation pruning operation to the another layer, the another activation pruning operation to prune one or more tensors to be generated by the another layer based on another activation threshold.

17. The one or more non-transitory computer-readable media of claim 11, wherein selecting the layer comprises:
selecting the layer based on an amount of internal parameters of the layer, an amount of computations in the layer, a type of the layer, or some combination thereof.

18. The one or more non-transitory computer-readable media of claim 11, wherein the operations further comprise:
further modifying the neural network by adding a weight pruning operation to the selected layer, the activation pruning operation to prune a kernel of the selected the layer based on a weight threshold by modifying an absolute value of a weight in the kernel to zero,
wherein the absolute value of the weight is lower than the weight threshold.

19. The one or more non-transitory computer-readable media of claim 18, wherein the neural network has been trained to determine the absolute value of the weight.

20. The one or more non-transitory computer-readable media of claim 18, wherein determining the second activation threshold comprises:
determining the second activation threshold after adding the weight pruning operation to the layer.

21. An apparatus, comprising:
a computer processor for executing computer program instructions; and
a non-transitory computer-readable memory storing computer program instructions executable by the computer processor to perform operations for modifying a neural network, the operations comprising:
inputting a dataset into the neural network, the neural network comprising a plurality of layers,
selecting a layer from the plurality of layers in the neural network, the selected layer in the neural network generating a tensor based on the dataset,
pruning the tensor based on a first activation threshold by modifying an absolute value of an activation in the tensor to zero, wherein the absolute value of the activation is lower than the first activation threshold,
determining an accuracy of the neural network based on an output of the neural network, the neural network generating the output based on the pruned tensor,
determining a second activation threshold based on the first activation threshold and the accuracy of the neural network, the second activation threshold having a different value from the first activation threshold, and
modifying the neural network by adding an activation pruning operation to the layer, the activation pruning operation to prune one or more tensors to be generated by the layer based on the second activation threshold.

22. The apparatus of claim 21, wherein determining the second activation threshold comprises:
determining an accuracy loss caused by pruning the tensor based on the accuracy of the neural network;
determine whether the accuracy loss exceeds a threshold;
in response to determining that the accuracy loss is lower than the threshold, determining the second activation threshold by increasing the first activation threshold; and
in response to determining that the accuracy loss exceeds the threshold, determining the second activation threshold by decreasing the first activation threshold.

23. The apparatus of claim 21, wherein the operations further comprise determining the first activation threshold based on a third activation threshold by:
inputting an additional dataset into the neural network, the layer in the neural network generating an additional tensor based on the additional dataset;
pruning the additional tensor based on a third activation threshold, wherein the third activation threshold is different from the first activation threshold and the second activation threshold;
determining an additional accuracy of the neural network based on an additional output generated by the neural network based on the pruned additional tensor; and
determining the first activation threshold based on the third activation threshold and the additional accuracy of the neural network.

24. The apparatus of claim 21, wherein the operations further comprise:
further modifying the neural network by adding a weight pruning operation to the layer, the activation pruning operation to prune a kernel the layer based on a weight threshold by modifying an absolute value of a weight in the kernel to zero,
wherein the absolute value of the weight is lower than the weight threshold.

25. The apparatus of claim 21, wherein the operations further comprise:
selecting another layer in the neural network; and
modifying the neural network by adding another activation pruning operation to the another layer, the another activation pruning operation to prune one or more tensors to be generated by the another layer based on another activation threshold.
